(19) United States
(12) Patent Application Publication
(10) Pub. No.: US 2009/0019490 A1
(43) Pub. Date: Jan. 15, 2009

(54) PROGRAM SELECTION SUPPORT DEVICE

(76) Inventor: Kentaro Tanikawa, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/628,783

(22) PCT Filed: Jun. 15, 2005
(86) PCT No.: PCT/JP2005/010929

§ 371 Date: Mar. 6, 2008

(30) Foreign Application Priority Data
Jun. 15, 2004 (JP) 2004-177515

(51) Int. Cl. H04N 5/445

(52) U.S. Cl. 725/44

(57) ABSTRACT

A program selection support device 200 that displays a program selection list that is a list of identifiers of broadcast programs selected as selection candidates from among all the broadcast programs to be broadcast in a predetermined period, the program selection support device comprising: a program selection list creating unit 209 operable to classify pieces of provider specifying information, each specifying a list provider that permits the program selection support device to display a program selection list of the list provider, into groups according to an attribute of each list provider, and register the pieces of provider specifying information on a recording medium in one-to-one association with the groups and register a program selection list of each list provider on the recording medium in one-to-one association with the pieces of provider specifying information; a group selection list managing unit 204 operable to designate one of the groups registered on the recording medium; and a display control unit 206 operable to acquire the program selection list of the list provider specified by one of the pieces of provider specifying information belonging to the designated group, and display a program selection list including identifiers of selection candidates included in the acquired program selection list.

### TECHNICAL FIELD

The present invention relates to a program selection support device that provides support for a user to select a program out of broadcast programs, and especially relates to a technique to easily and quickly select a program.

### BACKGROUND ART

In recent year, it has been common to perform timer preprogramming for recording a broadcast program by creating an electronic program guide, which is in the same format as a program guide on newspapers or the likes, based on program information externally acquired via broadcast or telecommunications lines. The created electronic program guide is displayed on a monitor so that a user can select a desired broadcast program from the program guide.

As a result, it is not necessary for the user to see a program guide on a newspaper to select a program. The user can select a desired program by comparing broadcast programs to be broadcast in the same time slot on the electronic program guide, to view the program or preprogram recording of the program.

Patent Document 1 discloses a technique for selecting a program or performing preprogramming using the above-described electronic program guide.

Patent Document 2 discloses a technique for marking, on an electronic program guide displayed on a monitor, a program to be recorded by preprogramming performed by another user of the same broadcast receiving device.

With this technique, the user can check which program is scheduled to be recorded by preprogramming performed by said another user. Therefore, the user can quickly select a desired program to view the program or preprogram recording of the program, without duplication in the same time slot.

However, a display area on a monitor is limited, and it is impossible to show all the programs to be broadcast in a given period on the screen at the same time. Therefore, with the above-described conventional technique, if the desired program is not included in the on-screen part of the electronic program guide, the user is required to repeat an operation for scrolling the program guide. This is a problem.

Also, since the number of channels for broadcasting has rapidly increased in recent years, it is difficult with the above-described conventional technique to check through the entire electronic program guide to see whether a desired program is scheduled to be broadcast or not. Therefore, even if a desired program is scheduled, the user might miss preprogramming recording or viewing of the program. This also is a problem.

Patent Document 1: Japanese Laid-open Patent Application Publication No. H09-331484

### Patent Document 2: Japanese Laid-open Patent Application Publication No. 2000-69381

### DISCLOSURE OF THE INVENTION

To solve the above-described problems, the present invention provides a program selection support device that allows a user to easily and quickly select a desired program without missing the program.

For this purpose, the present invention provides a program selection support device that displays a program selection list that is a list of identifiers of broadcast programs selected as selection candidates from among all the broadcast programs to be broadcast in a predetermined period, the program selection support device comprising: a group registration unit operable to classify pieces of provider specifying information, each specifying a list provider that permits the program selection support device to display a program selection list of the list provider, into groups according to an attribute of each list provider, and register the pieces of provider specifying information on a recording medium in one-to-one association with the groups; a program selection list registration unit operable to register a program selection list of each list provider on the recording medium in one-to-one association with the pieces of provider specifying information; a group designation unit operable to designate one of the groups registered on the recording medium; and a display control unit operable to acquire the program selection list of the list provider specified by one of the pieces of provider specifying information belonging to the designated group, and display a program selection list including identifiers of selection candidates included in the acquired program selection list.

The present invention also provides a program selection support method for displaying a program selection list that is a list of identifiers of broadcast programs selected as selection candidates from among all the broadcast programs to be broadcast in a predetermined period, the program selection support method comprising: a group registration step of classifying pieces of provider specifying information, each specifying a list provider that permits the program selection support device to display a program selection list of the list provider, into groups according to an attribute of each list provider, and registering the pieces of provider specifying information on a recording medium in one-to-one association with the groups; a program selection list registration step of registering a program selection list of each list provider on the recording medium in one-to-one association with the pieces of provider specifying information; a group designation step of designating one of the groups registered on the recording medium; and a display control step of acquiring the program selection list of the list provider specified by one of the pieces of provider specifying information belonging to the designated group, and displaying a program selection list including identifiers of selection candidates included in the acquired program selection list.

The present invention also provides a computer program for having a program selection support device execute a program selection support processing procedure, the program selection support device displaying a program selection list that is a list of identifiers of broadcast programs selected as selection candidates from among all the broadcast programs to be broadcast in a predetermined period, the program selection support processing procedure comprising: a group registration step of classifying pieces of provider specifying information, each specifying a list provider that permits the program selection support device to display a program selection list of the list provider, into groups according to an attribute of each list provider, and registering the pieces of provider specifying information on a recording medium in one-to-one association with the groups; a program selection list registration step of registering a program selection list of each list provider on the recording medium in one-to-one association with the pieces of provider specifying information; a group designation step of designating one of the groups registered on the recording medium; and a display control step of acquiring the program selection list of the list provider specified by one of the pieces of provider specifying information belonging to the designated group, and displaying a program selection list including identifiers of selection candidates included in the acquired program selection list.

The present invention also provides an integrated circuit that is used for a program selection support device that displays a program selection list that is a list of identifiers of broadcast programs selected as selection candidates from among all the broadcast programs to be broadcast in a predetermined period, the integrated circuit comprising: a group registration unit operable to classify pieces of provider specifying information, each specifying a list provider that permits the program selection support device to display a program selection list of the list provider, into groups according to an attribute of each list provider, and register the pieces of provider specifying information on a recording medium in one-to-one association with the groups; a program selection list registration unit operable to register a program selection list of each list provider on the recording medium in one-to-one association with the pieces of provider specifying information; a group designation unit operable to designate one of the groups registered on the recording medium; and a display control unit operable to acquire the program selection list of the list provider specified by one of the pieces of provider specifying information belonging to the designated group, and display a program selection list including identifiers of selection candidates included in the acquired program selection list.

With the stated structure, the user can designate at any time a group including members who have highly possibly selected a program in a category desired by the user from groups into any of which each provider of a program selection list is classified. The user can acquire and refer to the program selection list of a list provider belonging to the designated group. Therefore, the user can easily and quickly select a desired program by referring to the acquired program selection list without thoroughly checking the program guide.

For example, the user can register program selection lists of users having a common hobby in a single group, and accordingly, if the user wishes to select a program relating the hobby, the user can easily find a desired program by referring to the program selection list of the group.

Here, the display control unit may include a program information storing subunit operable to store a plurality of pieces of broadcast program information each indicating a correspondence between a piece of program content information including an identifier of a broadcast program to be broadcast in the predetermined period and a broadcast channel and a time slot of the broadcast program, and a program guide displaying subunit operable to specify, on every reception of a designation of the identifier input by a user from the program selection list displayed by the display control unit, a predetermined range of broadcast channels and time slots including the broadcast channel and the time slot corresponding to the piece of program content information including the identifier input by the user, based on the pieces of broadcast program information, and display a program guide in which pieces of program content information respectively corresponding to the specified broadcast channels and time slots are arranged, one of coordinate axes of the program guide indicating the broadcast channels and the other one of the coordinate axes indicating the time slots.

Here, the display control unit may include a list acquiring subunit operable to acquire a program selection list of each list provider specified by the provider specifying information belonging to the designated group, a list creating subunit operable to create the program selection list including the identifiers of all the selection candidates included in each of the acquired program selection lists, and a list displaying subunit operable to display the created program selection list.

With the stated structure, the program guide including a program designated by the user from the program selection list is controlled to be always displayed on the display unit. As a result, it is possible to easily and quickly display the part of the program guide including the desired program without repeating an operation for scrolling the program guide. Therefore, the user can easily select a program after checking whether any other program to be selected is included in the displayed program guide.

Here, the program selection list of the list provider may include selection status information for each identifier included in the program selection list, the selection status information indicating whether the identifier has already been selected, and if the selection status information indicates that the identifier has already been selected, the program guide displaying subunit may display the program guide to which are added the selection status information and a piece of the provider specifying information associated with the program selection list of the list provider to the piece of program content information including the identifier.

With the stated structure, the user can easily specify, from the displayed screen, a program that has been already selected by the provider of the program selection list. Therefore, the user can know a program that has been attracting a lot of attention of the members in the group. If a party is planned by the group, the user can previously watch the program viewed by many members in the group. As a result, the user can bring the topic about the program in the party, and activate communication among the members in the party.

Here, each piece of program content information may include a program attribute, and the program selection support device may further comprise: a program selection unit operable to select a piece of the program content information from the program guide in accordance with a user's instruction; a relevant program search unit operable to search for a piece of program content information including a common program attribute with the selected one of the pieces of the program content; and a program list update unit operable, if the piece of program content information including the common program attributed has found by the search, to add an identifier included in the found piece of the program content information to the program selection list displayed by the display control unit.

With the stated structure, a program relating the program selected by the user is added to the program selection list. As a result, the user can include the relating program in the list of the selection candidates.

Here, the program list update unit may delete, from the program selection list displayed by the display control unit, an identifier included in a piece of the program content information that has not been selected within a predetermined number of selections performed by the program selection unit.

With the stated structure, a program that has not been selected for a predetermined number of times successively is removed from the program selection list. The possibility that such a program becomes a selection candidate of the user is low. Therefore, the user can easily and quickly designate a program from the selection candidates.

Here, the program selection support device may further comprise a judging unit operable to judge whether the identifier included in the selected one of the pieces of the program content is contained in the program selection list displayed by the display control unit, wherein if the judging unit judges affirmatively, the program list update unit may delete the identifier from the program selection list displayed by the display control unit.

With the stated structure, a program that has already been selected is removed from the program selection list. As a result, the user can designate a desired program from the program selection list without designating by mistake a program that has already been selected.

Here, the program selection support device may further comprise a judging unit operable to judge whether the identifier included in the selected one of the pieces of the program content is contained in the program selection list, wherein if the judging unit judges affirmatively, the display unit may display the identifier in a display mode different from a display mode for the other identifiers in the program selection list.

With the stated structure, the program already selected is displayed in such a manner that the program can be distinguished from the other programs. As a result, the user can designate a desired program from the program selection list without designating by mistake a program that has already been selected.

Here, the program selection support device may further comprise: a receiving unit operable to receive, from the user, a selection condition specifying the program attribute; and a list creating unit operable to specify a piece of program content information including a common program attribute with the program attribute specified by the selection condition, and create the program selection list based on the identifier included in the specified piece of program content information.

With the stated structure, the program selection list is created based on the program attribute of the program desired by the user. As a result, the user can easily display the program guide including the desired program with reference to the program selection list. Therefore, the user can easily select a program after checking whether any other program to be selected is included in the displayed program guide.

Here, the program selection support device may further comprise: an extraction unit operable, on every selection of a piece of program content information, to extract the identifier and the program attribute from the selected piece of program content information; and a recording unit operable to record the extracted identifier and program attribute in the program information storing subunit in association with an evaluation score to be updated based on a number of extractions performed by the extraction unit, wherein the receiving unit may receive a selection condition specifying a range of time slots and broadcast channels from the user, the list creating unit may further include a specifying subunit operable to specify an identifier or a program attribute whose evaluation score is more than a threshold value, and a selection subunit operable to select a piece of program content information including the specified identifier or program attribute within the specified range of time slots and broadcast channels, and the list creating unit may create the program selection list based on the selected piece of program content information.

With the stated structure, the program selection list is created based on the frequency with which the identifiers or the program attributes of the programs have been selected by the user in the past. As a result, the user can easily display the program guide including the desired program with reference to the program selection list. Therefore, the user can easily select after checking whether any other program to be selected is included in the displayed program guide.

Here, the program selection support device may be connected with external program support devices via a network, the group registration unit may further include a receiving subunit operable to receive pieces of provider specifying information, each specifying a list provider who has requested registration, from the external program support devices, a group specification receiving subunit operable to receive a group designation based on an attribute of the list provider, and a list provider registration subunit operable to classify the pieces of provider specifying information into a group designated by the group designation, and record the pieces of provider specifying information on the recording medium, and the program selection list registration unit may include an acquiring subunit operable to acquire, from the external program support device, a program selection list associated with a piece of provider specifying information of a list provider who has requested registration, and an acquired list registration subunit operable to register, on the recording medium, the acquired program selection list registration in one-to-one association with a piece of provider specifying information of the list provider who has requested registration.

With the stated structure, it is possible to register wide range of providers of program selection lists without limitation of location. As a result, it becomes possible to classify various providers with different attributes into groups. This effectively widens the selectable range of programs by means of group designation.

Here, each of the external program selection support devices may comprise: a group storing unit operable to classify the pieces of provider specifying information into groups according to an attribute of the list provider specified by each piece of provider specifying information, and store the classified pieces of provider specifying information; and a program list storing unit operable to store a program list of each list provider in one-to-one association with the pieces of provider specifying information, and the receiving subunit may receive, from each external program selection support device, a designation of a group that is permitted to access the program selection list of the list provider that has requested registration, the list provider registration subunit may classify the group into a group designated as to a piece of provider specifying information of the list provider and register the group on the recording medium, the acquiring subunit may notify the external program selection support device of the group and acquire the program selection list associated with each piece of the provider specifying information belonging to the group, the display control unit may further acquire the program selection list associated with the provider specifying information belonging to the group that is permitted to access the program selection list by the list provider specified by the piece of provider specifying information belonging to the designated group, and display the program selection list including identifiers of selection candidates included in the acquired program selection list.

With the stated structure, the user can acquire and refer to, in addition to a program selection list of the list provider, program selection lists of other list providers permitted by the list provider. As a result, the user can acquire more of valuable information about the selection candidates.

Here, the display control unit may include a provider designation receiving unit operable to receive a designation of a piece of provider specifying information whose program selection list is to be displayed among the pieces of provider specifying information belonging to the designated group, a designated list acquiring unit operable to acquire a program selection list associated with the designated piece of provider specifying information, and a displaying subunit operable to display the acquired program selection list.

With the stated structure, the user can refer to individual program selection list of each of the list providers belonging to the group designated by the user. As a result, especially in the case where there is any provider whose taste is similar to the user, the user can refer to the program selection list of such a provider in priority, and quickly select a desired program.

Here, the program selection list of the list provider may include selection status information for each identifier included in the program selection list, the selection status information indicating whether the identifier has already been selected, and the display control unit may include a list acquiring subunit operable to acquire a program selection list of each list provider specified by the provider specifying information belonging to the designated group, a list creating subunit operable to create the program selection list including only the identifiers whose selection status information indicates that the identifier has already been selected, and a list displaying unit operable to display the created program selection list.

Here, the recording medium may register thereon a user program selection list that is a program selection list of a user of the program selection support device, and the list displaying unit may display a complex program selection list including the created program selection list and the user program selection list.

With this structure, programs that have been selected by list providers belonging to the group designated by the user are displayed in the program selection list. As a result, the user can easily specify programs that have been attracting a lot of attention of the members in the group, and quickly select a desired program.

Here, the list providers may include a user of an external program selection support device other than the program selection support device, each piece of provider specifying information may include device specifying information specifying a program selection support device to be used by the list provider, the display control unit may include a list acquiring unit operable to acquire a program selection list of the list provider specified by the provider specifying information belonging to the designated group, a list creating unit operable to create a specifying-information-added program selection list by adding the piece of provider specifying information of the list provider to the identifier of the selection candidate included in the acquired program selection list, and a program information creating unit operable to create, based on the pieces of broadcast program information and the specifying-information-added program selection list, specifying-information-added broadcast program information by adding the piece of the provider specifying information to a piece of program content information including a common identifier with identifiers included in the specifying-information-added program selection list, and the program guide displaying unit may display, based on the specifying-information-added broadcast program information, among pieces of program content information corresponding to the specified broadcast channels and time slots, pieces of the specifying-information-added broadcast program information whose device identifying information indicates the external program selection support device and pieces of the specifying-information-added broadcast program information whose device identifying information indicates the program selection support device in different manners.

With this structure, the user can easily identify whether the selection candidates displayed in the program guide is of the user of the program selection support device or of the user of the external program selection support device. As a result, the user can smoothly perform program selection.

Here, the program selection list of the list provider may include a pair of preprogramming status information and transferability information for each identifier included in the program selection list of the list provider, the preprogramming status information indicating whether the selection candidate associated with the identifier has already been preprogrammed for recording and the transferability information indicating whether the preprogrammed selection candidate is transferable, if the preprogramming status information associated with the identifier of the selection candidate included in the program selection list indicates that the selection candidate has already been preprogrammed, the list creating unit may create the specifying-information-added program selection list by adding the preprogramming status information and the transferability information to the identifier, the program information creating unit may create, based on the pieces of broadcast program information and the created specifying-information-added program selection list, the specifying-information-added broadcast program information by further adding the preprogramming status information and the transferability information to the piece of program content information including a common identifier with identifiers each including the preprogramming status information and the transferability information and included in the specifying-information-added program selection list, and the program guide displaying unit may display, based on the specifying-information-added broadcast program information to which the preprogramming status information and the transferability information are added, among pieces of program content information corresponding to the specified broadcast channels and time slots, pieces of the specifying-information-added broadcast program information whose device identifying information indicates the external program selection support device and pieces of the specifying-information-added broadcast program information whose device identifying information indicates the program selection support device in different manners.

With the stated structure, the user can previously know whether the selection candidates whose recording has been preprogrammed by the external device can be transferred to the user's device. As a result, even if the user wishes to preprogram recording of a program whose recording has been already preprogrammed by another user of the program selection support device, the user can smoothly decide whether to forcibly perform such preprogramming based on the transferability information.

Here, the group designation unit may designate a plurality of groups from among the groups registered on the recording medium, the display control unit may include a list acquiring subunit operable to acquire a program selection list of each list provider specified by pieces of provider specifying information belonging to the designated groups, a list creating subunit operable to create the specifying-information-added program selection list by adding the pieces of the provider specifying information and pieces of group specifying information specifying the list providers, and a program information creating unit operable to create, based on the pieces of broadcast program information and the specifying-information-added program selection list, specifying-information-added broadcast program information by adding the pieces of the provider specifying information to a piece of program content information including a common identifier with identifiers included in the specifying-information-added program selection list, and the program guide displaying unit may display, based on the specifying-information-added program guide information, among pieces of program content information corresponding to the specified broadcast channels and time slots, pieces of the specifying-information-added broadcast program information in different display modes depending on the group indicated by the group specifying information.

With the stated structure, the user can easily identify which group each of the selection candidates displayed in the program guide belongs to. As a result, the user can smoothly select a program.

Here, the list providers may include a user of an external program selection support device other than the program selection support device, each piece of provider specifying information may include device specifying information specifying a program selection support device to be used by the list provider, the program selection list of the list provider may include selection status information for each identifier included in the program selection list, the selection status information indicating whether the identifier has already been selected, and the display control unit may include a list acquiring subunit operable to acquire a program selection list of each list provider specified by the provider specifying information belonging to the designated group, a list creating unit operable to create a specifying-information-added program selection list by adding the piece of provider specifying information of the list provider to the identifier of the selection candidate included in the acquired program selection list, and a program information creating unit operable to create, based on the pieces of broadcast program information and the specifying-information-added program selection list, specifying-information-added broadcast program information by adding the selection status information and the piece of the provider specifying information to a piece of program content information including a common identifier with identifiers included in the specifying-information-added program selection list, and the program guide displaying unit may include a program guide creating subunit operable to specify broadcast channels and time slots including the broadcast channel and the time slot corresponding to the piece of program content information including the identifier input by the user, based on the specifying-information-added broadcast program information, to create the program guide, a judging subunit operable to judge whether the number of pieces of the program content information, associated with the same time slot and including the selection status information and provider specifying information whose device specifying information indicates the program selection support device, is more than a threshold value, and a displaying subunit operable, if the judging subunit judges affirmatively, to display the program content information associated with the same time slot in a display mode different from a display mode for the other pieces of program content information are displayed.

With the stated structure, the user can tell, from the displayed program guide, the time slot of the program that can not be selected by the program selection support device. As a result, the user is prevented from selecting the program that has already been selected by another user of the program selection support device.

### BRIEF DESCRIPTION OF THE DRAWINGS

FIG. 1 is a functional block diagram showing a structure of a program selection support device 100 according to the first embodiment of the present invention;

FIG. 2 is a specific example of a program selection list;

FIG. 3 is a specific example of a full program guide;

FIG. 4 is a specific example of broadcast program names included in a program selection list and a GUI screen of an on-screen program guide;

FIG. 5 is a flowchart showing operations for program selection performed by the program selection support device 100;

FIG. 6 is a part of a flowchart showing operations for updating a program selection list performed by the program selection support device 100;

FIG. 7 is a part of a flowchart showing operations for updating a program selection list, performed by the program selection support device 100;

FIG. 8 is a part of a flowchart as a modification 1 of the flowchart shown in FIG. 6, showing operations for updating a program selection list and performed by the program selection support device 100;

FIG. 9 is a part of a flowchart as a modification 1 of the flowchart shown in FIG. 6, showing operations for updating a program selection list and performed by the program selection support device 100;

FIG. 10 is a part of a flowchart as a modification 2 of the flowchart shown in FIG. 6, showing operations for updating a program selection list and performed by the program selection support device 100;

FIG. 11 is a part of a flowchart as a modification 2 of the flowchart shown in FIG. 6, showing operations for updating a program selection list and performed by the program selection support device 100;

FIG. 12 is a functional block diagram showing a structure of a program selection support device 200 according to the second embodiment of the present invention;

FIG. 13 shows specific examples of an individual program selection list;

FIG. 14 shows a specific example of registration information;

FIG. 15 shows specific examples of per-user registration group information;

FIG. 16 shows a specific example of a complex program selection list;

FIG. 17 is a specific example of a correspondence program guide;

FIG. 18 is a specific example of a complex program selection list and an on-screen correspondence program guide displayed on a display unit 105;

FIG. 19 is a flowchart showing part of operations for creating a complex program selection list, performed by a program selection list creating unit 209;

FIG. 20 is a flowchart showing part of operations for creating a complex program selection list, performed by a program selection list creating unit 209;

FIG. 21 is a flowchart showing operations for complex program selection performed by the program selection support device 200;

FIG. 22 is a flowchart showing part of operations for updating a program selection list performed by the program selection support device 200;

FIG. 23 is a flowchart showing part of operations for updating a program selection list performed by the program selection support device 200;

FIG. 24 shows an example case where selection candidates of different broadcast wave types are selected from the program selection list; and

FIG. 25 is a specific example of a tree structure of per-user registration group information.

### BEST MODE FOR CARRYING OUT THE INVENTION

### First Embodiment

### <Structure>

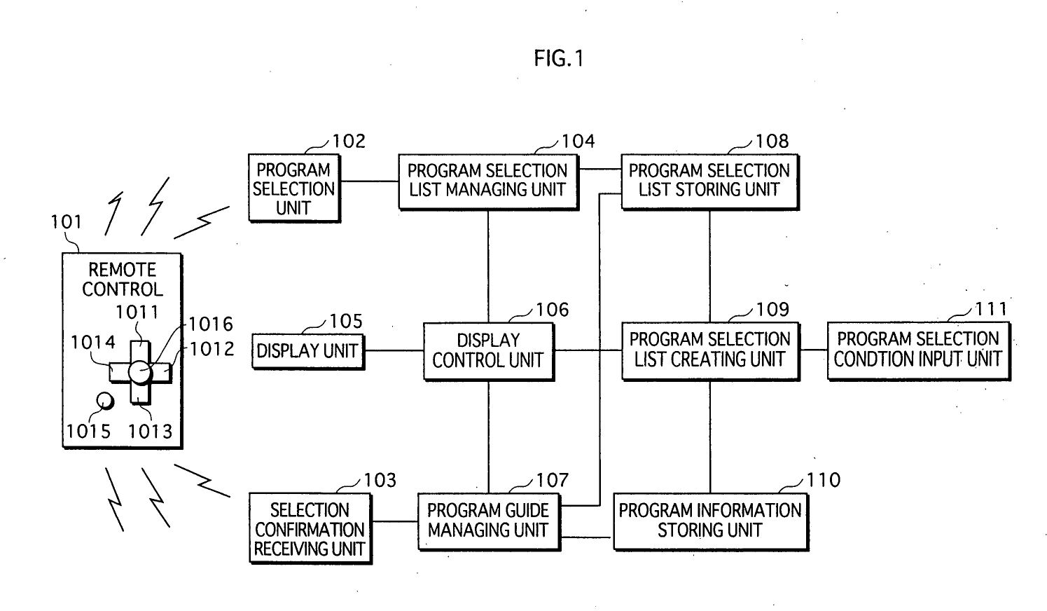

FIG. 1 is a functional block diagram showing a structure of a program selection support device 100 according to the first embodiment of the present invention. As FIG. 1 shows, the program selection support device 100 includes a remote control 101, a program selection unit 102, a selection confirmation receiving unit 103, a program selection list managing unit 104, a display unit 105, a display control unit 106, a program guide managing unit 107, a program selection list storing unit 108, a program selection list creating unit 109, a program information storing unit 110, and a program selection condition input unit 111.

A remote control 101 is a device for inputting various instructions given by a user operating operation keys. More specifically, the remote control 101 inputs a program selection process start-up instruction, a program selection instruction, a selection confirmation instruction and a program selection condition instruction to the program selection unit 102, the selection confirmation receiving unit 103 and the program selection condition input unit 112.

The remote control 101 includes, as the operation keys, an up key 1011, a right key 1012, a down key 1013, a left key 1014, a switch key 1015, and a selection confirmation key 1016.

Here, the “program selection process start-up instruction” is an instruction for starting up a program selection process which is described later.

The “program selection instruction” is instruction for selecting a program name (candidate program name) of a broadcast program (candidate program) among broadcast programs included in a program selection list shown on a GUI (Graphic User Interface) screen displayed on the display unit 105. The input of this instruction is confirmed by pressing the selection confirmation key 1016 after moving a cursor onto a program name to be selected from the selection list shown on the GUI screen by operating the up key 1011 and the down key 1013.

The “program selection list” is a list of broadcast program names that is created by the program selection list creating unit 109 from broadcast program names included in broadcast program information based on the program selection condition input by the program selection condition input unit 111. More specifically, the program selection list includes names of programs that satisfy the program selection condition and successive non-selection counts relating to the programs. The program names and the successive non-selection counts are in one-to-one correspondence.

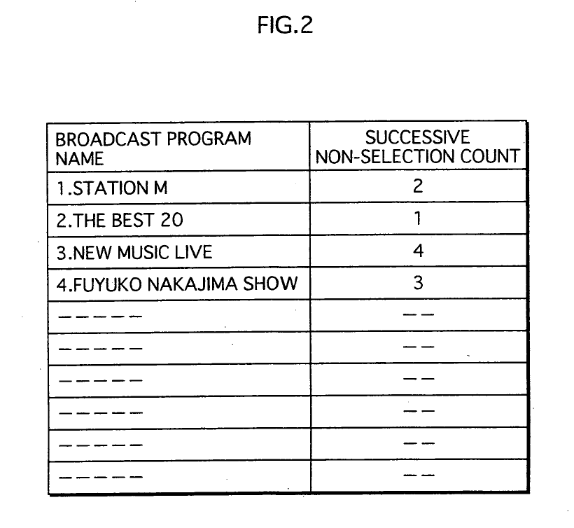

Here, the “successive non-selection count” represents the number of times the corresponding broadcast program name is not selected as the candidate program in a row. FIG. 2 is a specific example of the program selection list.

The “broadcast program information” is prestored in the program information storing unit 110, and represents a relation among program content information indicating the content of each program to be broadcast in a predetermined period, a broadcast channel of the program, a time slot in which the program is broadcast, and a selection confirmation flag indicating whether the selection confirmation instruction is given as to the program.

Here, the “program content information” includes broadcast program names as identifiers of the broadcast programs, and program attribute information indicating program attributes, such as names of main performers and names of genres.

Here, the “program attribute” is an attribute dependent on a broadcast program, such as a name of genre and names of performers (e.g. a name of a principal performer).

The “selection confirmation instruction” is an instruction for confirming a selection of a time slot in which the program is broadcast, the broadcast channel and the program content information from the GUI of an on-screen program guide displayed by the display unit 105. The input of this instruction is confirmed by pressing the selection confirmation key 1016 after moving a cursor onto program content information to be selected from the on-screen program guide as a GUI screen by operating the up key 1011, the down key 1013, the left key 1014 and the right key 1012.

Here, the “on-screen program guide” is created by extracting program content information corresponding to broadcast times and broadcast channels in a predetermined range from a full program guide created by locating, in a plane formed with the vertical axis indicating broadcast times and the horizontal axis indicating broadcast channels, program content information indicated by the broadcast program information prestored in the program information storing unit 110. More specifically, the on-screen program guide is a program guide including broadcast channels and time slots within a predetermined range centered around the time slot and the broadcast channel of a candidate program selected and instructed by the input of the program selection instruction. For example, if the time slot of the candidate program is 20 to 21 o'clock on May 1, 2004, the predetermined range may include 20 to 21 o'clock and extra 1 hours ahead and behind the time slot, namely 19 to 22 o'clock. If the broadcast channels are arranged in the order of 2, 4, 6, 8, 10 and 12 (in ascending order) and the broadcast channel of the candidate program is 6, the predetermined range may include the channel 6 and extra two channels ahead and behind the channel 6, namely channels 2 and 4 and 8 and 10.

The broadcast program names and the program selection list and the GUI screen of the on-screen program guide are displayed together on the screen of the display unit 105. The switching of the GUI screen, on which the cursor is to be displayed, can be performed by the operation of the switch key 1015.

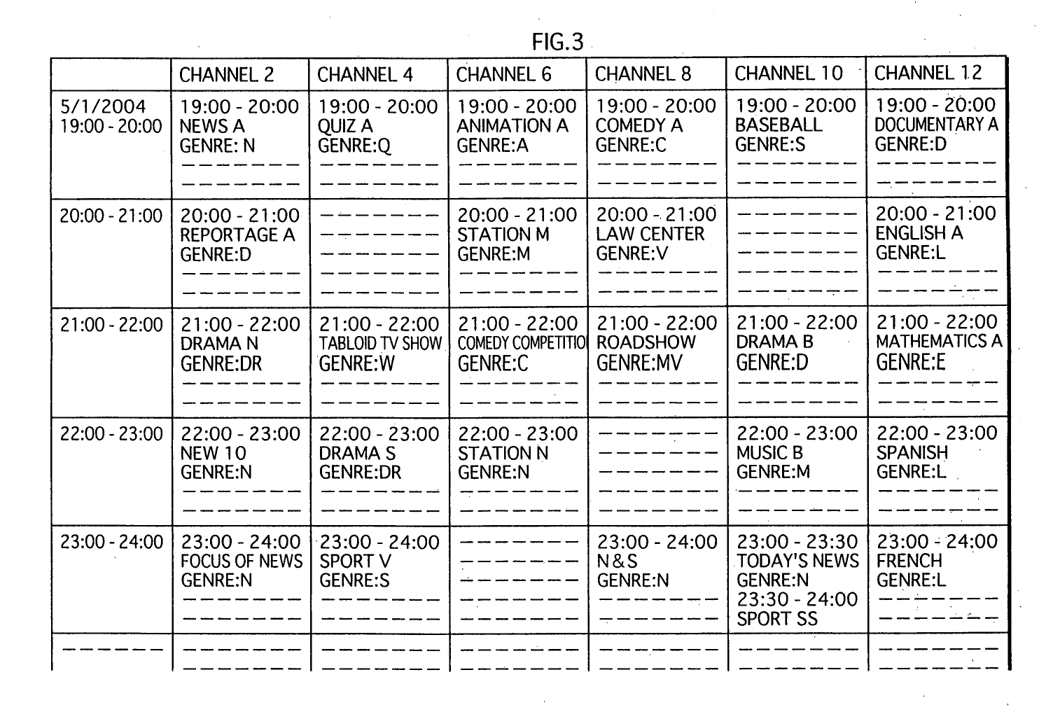

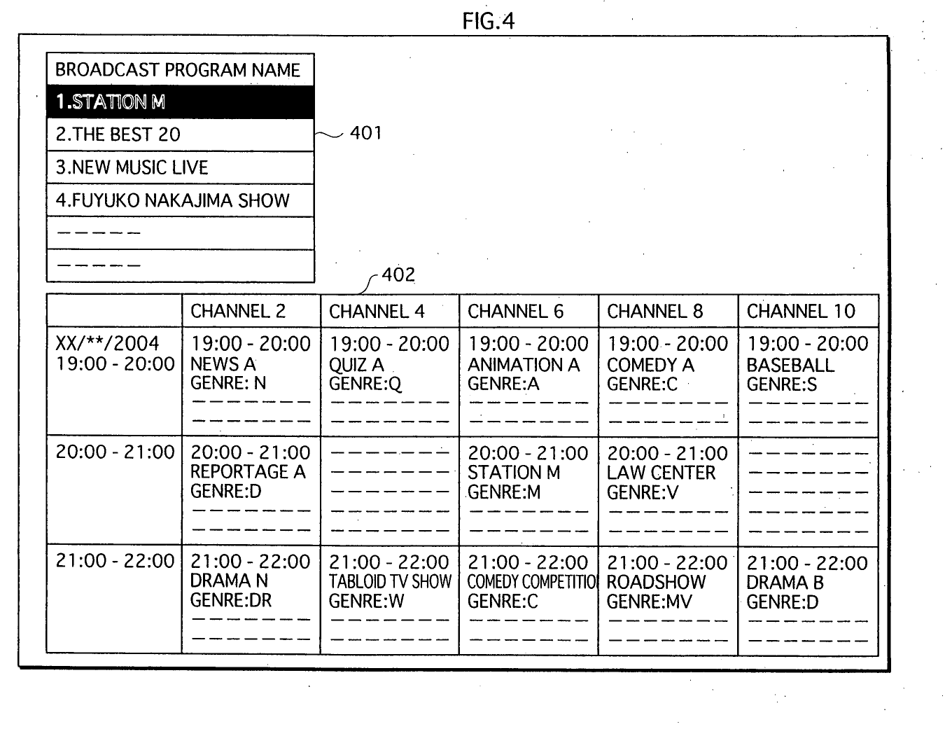

FIG. 3 shows a specific example of the full program guide, and FIG. 4 shows a specific example of the GUI screen of the broadcast program names included in the program selection list and the GUI screen of the on-screen program guide. A sign 401 in FIG. 4 indicates a specific example of the GUI screen of the program selection list, and a sign 402 in FIG. 4 indicates a specific example of the GUI screen of the on-screen program guide.

The “program selection condition instruction” is an instruction to input conditions for selecting broadcast programs to create the program selection list. More specifically, this instruction is for inputting, from the GUI screen for inputting program selection conditions displayed on the display unit 105, program selection conditions, such as a time slot, a broadcast channel, a program attribute (e.g. genre name), of the program to be selected. The program names to be included in the program selection list are selected in accordance with this instruction.

The program selection unit 102 notifies the program selection list managing unit 104 of the candidate program name selected from the GUI screen of the program selection list in accordance with the program selection instruction input by the operation of the selection confirmation key 1016 of the remote control 101.

The selection confirmation receiving unit 103 notifies the program guide managing unit 107 of the time slot, the broadcast channel, the program content information of the program confirmed on the GUI screen of the on-screen program guide by the selection confirmation instruction input by the operation of the selection confirmation key 1016 on the remote control 101.

The program selection list managing unit 104 monitors an update flag. The update flag is associated with the program selection list stored in the program selection list storing unit 108, and indicates whether the program selection list has been updated or not. If the update flag indicates “updated”, the program selection list managing unit 104 reads the program names included in the program selection list from the program selection list storing unit 108, and outputs the program names to the display control unit 106.

Here, the update flag indicates “updated” when the program selection device has been started up and in the initial status.

Upon receiving the notification of the candidate program name from the program selection unit 102, the program selection list managing unit 104 notifies the display control unit 106 of the program name.

The display control unit 106 generates the GUI screen of the selection list of the broadcast programs based on the program name input from the program selection list managing unit 104, displays the GUI screen on the display unit 105. If a GUI screen of the selection list has been already displayed on the display unit 105, the display control unit 106 deletes the old selection list and displays the new selection list on the display unit 105. Furthermore, upon receiving the notification of the candidate program name from the program selection list managing unit 104, the display control unit 106 notifies the program guide managing unit 107 of the candidate program name, and highlights the candidate name in the selection list displayed on the display unit 105. In the GUI 401 in FIG. 4, a candidate program name “station M” is highlighted.

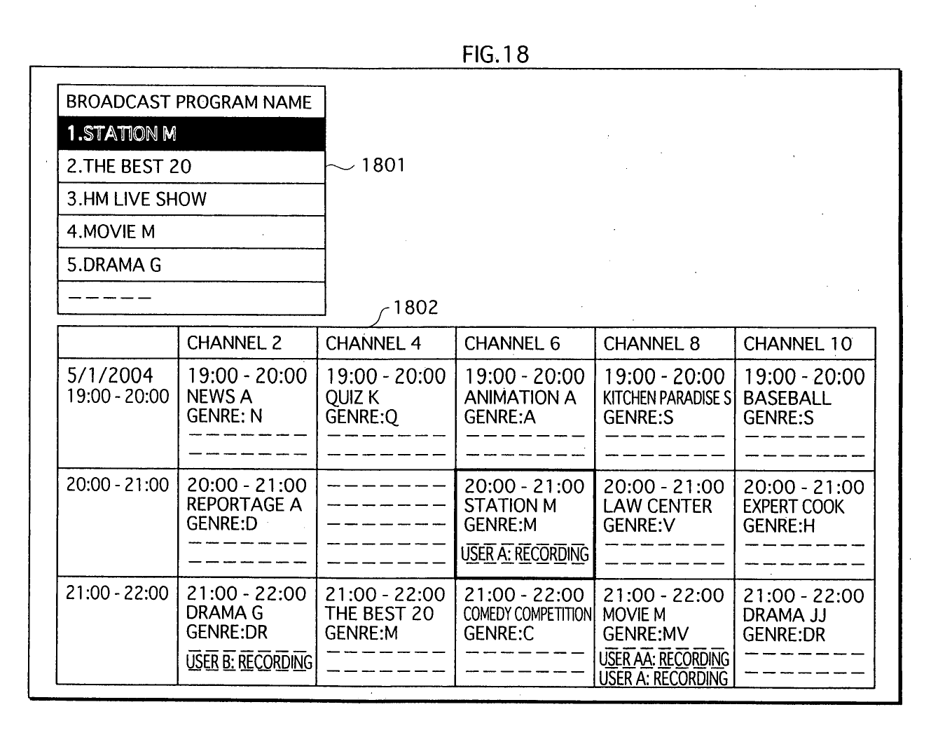

Also, the display control unit 106 generates a GUI screen of the on-screen program guide based on the on-screen program guide input by the program guide managing unit 107, displays the generated GUI screen on the display unit 105, and displays a cursor on a piece of program content information that includes the candidate program name, among pieces of program content information displayed in the on-screen program guide. In the GUI screen 402 in FIG. 4, the cursor (a frame in FIG. 18) is displayed around the program content information of the program “Station M” selected as a candidate program name from the GUI screen 401.

Upon receiving the notification of the time slot, the broadcast channel and the piece of the program content information of the selected and confirmed program from the program guide managing unit 107, the display control unit 106 highlights the piece of the program content information included in the GUI screen of the on-screen program guide displayed on the display unit 105.

The program guide managing unit 107 performs creation of the full program guide and the on-screen program guide, and update of the program selection list.

### Creation of Full Program Guide

The program guide managing unit 107 creates the full program guide based on each piece of the broadcast program information stored in the program information storing unit 110, and stores the created full program guide in the program information storing unit 110.

### Creation of On-Screen Program Guide

Upon receiving notification of the candidate program name from the display control unit 106, the program managing unit 107 specifies apiece of program content information including the candidate program name from the full program guide stored in the program information storing unit 110. Furthermore, the program managing unit 107 extracts a program guide constituted of time slots and the broadcast channels in a predetermined range centered around the time slot and the broadcast channel associated with the specified piece of the program content information. As a result, the on-screen program guide is created.

### Update of Program Selection List

Upon receiving notification of the time slot, the broadcast channel, and the program content information of the confirmed broadcast program from the selection confirmation receiving unit 103, the program guide managing unit 107 set a selection confirmation flag corresponding to the time slot, the broadcast channel, the program content information of the confirmed broadcast program such that the flag indicates “selection confirmed”. The selection confirmation flag is included in each piece of broadcast program information stored in the program information storing unit 110. The program guide managing unit 107 searches for a piece of program content information having a common program attribute with the piece of the program information of the confirmed program. If the search succeeds, the program guide managing unit 107 extracts a broadcast program name from the searched piece of the program content information, and adds the extracted broadcast name into the program selection list stored in the program selection list storing unit 108. Then, the Program managing unit 107 set 0 to the successive non-selection count, and set the update flag associated with the program selection list so as to indicate “updated”.

In this embodiment, a piece of program content information having a specific program attribute (e.g. genre name) in common is searched for.

Every time the program guide managing unit 107 receives the notification of the time slot, the broadcast channel, the program content information of the confirmed broadcast program from the selection confirmation receiving unit 103, the program guide managing unit 107 updates the successive non-selection count of the program selection list stored in the program list storing unit 108, and deletes a pair of a broadcast program name and a successive non-selection count, whose successive non-selection count is more than a threshold value, from the program selection list.

The program selection list storing unit 108 stores the program selection list in association with the update flag.

The program selection list storing unit 108 also stores a threshold value of the successive non-selection count.

Based on the condition for the program selection (e.g. range of the time slot, the range of the broadcast channel, the program attribute such as the genre name) input from the program selection condition input unit 111 unit 111, the program selection list creating unit 109 specifies a piece of program content information that satisfies the selection condition from the pieces of broadcast program information stored in the program information storing unit 110. Then the program selection list creating unit 109 creates a program selection list based on the broadcast program name included in the specified piece of the program content information, and stores the program selection list in the program selection list storing unit 108.

The program information storing unit 110 stores broadcast program information of each of broadcast program to be broadcast in a predetermined period.

The program selection condition input unit 111 receives a program selection condition instruction from the user via the remote control 101, and outputs the program selection condition specified by the program selection condition instruction to the program selection list creating unit 109.

### <Operations>

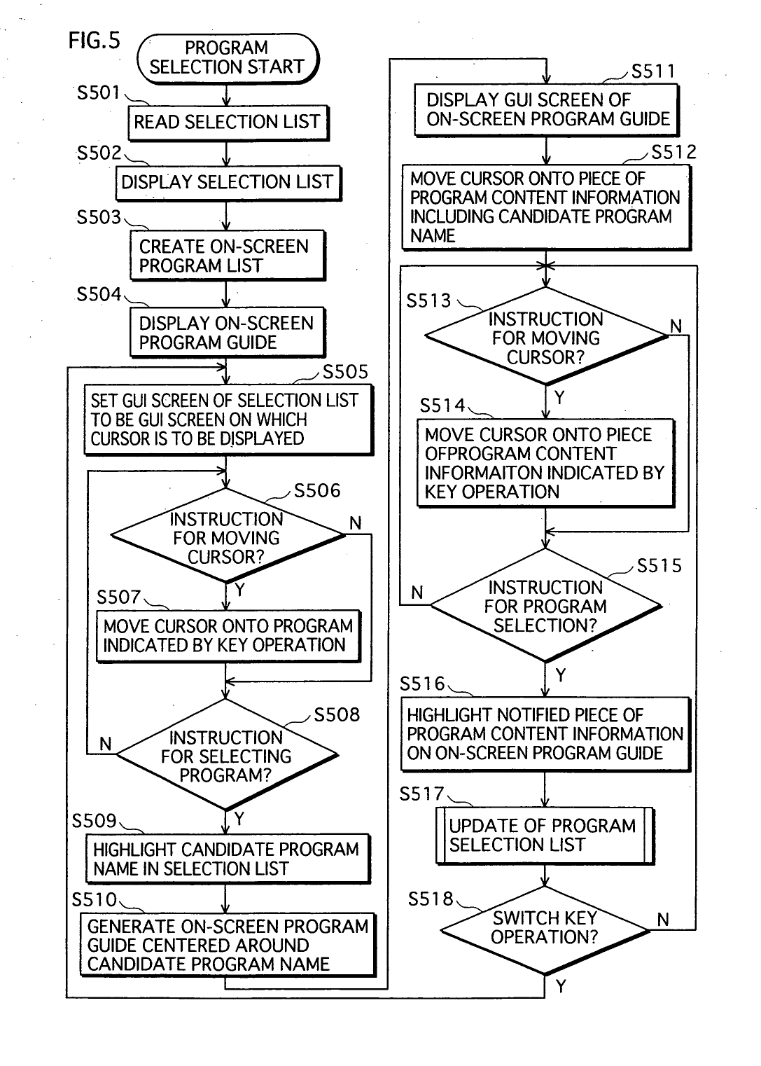

The following describes a program selection procedure performed by the program selection support device 100. FIG. 5 is a flowchart showing this procedure. The following explanation is made with reference to FIG. 5.

If receiving an instruction for starting up a program selection procedure from the remote control 101, the program selection list managing unit 104 reads broadcast program names to be contained in the program selection list, from the program selection list storing unit 108 (Step S501), outputs the names to the display control unit 106, and notifies the display control unit 106 of a program name set as an initial program name (e.g. the first one of the read program names).

The display control unit 106 generates a GUI screen of a selection list of broadcast program names based on the read broadcast program names and displays the GUI screen on the display unit 502 (Step S502), and highlights the initial program name in the selection list.

Next, the program guide managing unit 107 generates the full program guide based on the pieces of the broadcast program information stored in the program information storing unit 110, stores the generated full program guide in the program information storing unit 110. Upon receiving notification of the initial program name from the display control unit 106, the program guide managing unit 107 specifies a piece of program content information including the initial program name in the full program guide stored in the program information storing unit 110.

The display control unit 106 generates a GUI screen of the on-screen program guide based on the on-screen program guide input by the program guide managing unit 107 and displays the on-screen program guide on the display unit 105 (Step S504), sets a GUI screen on which a cursor is to be displayed as a GUI screen of the selection list (Step S505). If an instruction for moving the cursor by the up key 1011 or the down key 1013 is detected (Step S506: Y), the display control unit 106 moves the cursor (the highlight) onto a program indicated by the key operation (Step S507), and judges whether the program selection instruction has been input based on whether notification of a candidate program is transmitted from the program selection list managing unit 104 (Step S508).

If no instruction for moving the cursor is detected in Step S506 (Step S506: N), Step S508 is performed next.

If a program selection instruction is input in Step S508 (Step S508: Y), the display control unit 106 notifies the program guide managing unit 107 of the candidate program name, and highlights the candidate program name in the selection list displayed on the display unit 105 as shown in the GUI screen 401 in FIG. 4 (Step S509).

Next, upon receiving the notification of the candidate program name from the display control unit 106, the program guide managing unit 107 specifies a piece of program content information including the candidate program name in the full program guide stored in the program information storing unit 110. Furthermore, the program guide managing unit 107 extracts a program guide constituted of time slots and broadcast channels in a predetermined range centered around the time slot and the broadcast channel associated with the specified piece of the program content information to generate the on-screen program guide (Step S510), and outputs the on-screen program guide to the display control unit 106.

Next, the display control unit 106 generates a GUI screen of the on-screen program guide based on the on-screen program guide input by the program guide managing unit 107 and displays the GUI screen on the display unit 105 (Step S511), and moves the cursor onto the piece of program content information including the candidate program name as the GUI screen 402 in FIG. 4 shows (Step S512). If an instruction for moving the cursor by the up key 1011, the down key 1013, the left key 1014 or the right key 1012 is detected (Step S513: Y), the display control unit 106 moves the cursor (the highlight) onto a piece of program content information indicated by the key operation (Step S514), and judges whether the program selection instruction has been input based on whether notification of the candidate program is transmitted from the program selection list managing unit 104 (Step S515).

If the program selection instruction ahs been input, (Step S515: Y), the display control unit 106 highlights the notified program content information on the GUI screen of the on-screen program guide displayed on the display unit 105 (Step S516). After performing a procedure for update the program selection list described later (Step S517), if the switch instruction has been input by the operation of the switch key 1015, the display control unit 106 performs Step S505. If the switch instruction has not been input, the display control unit 106 performs Step S513.

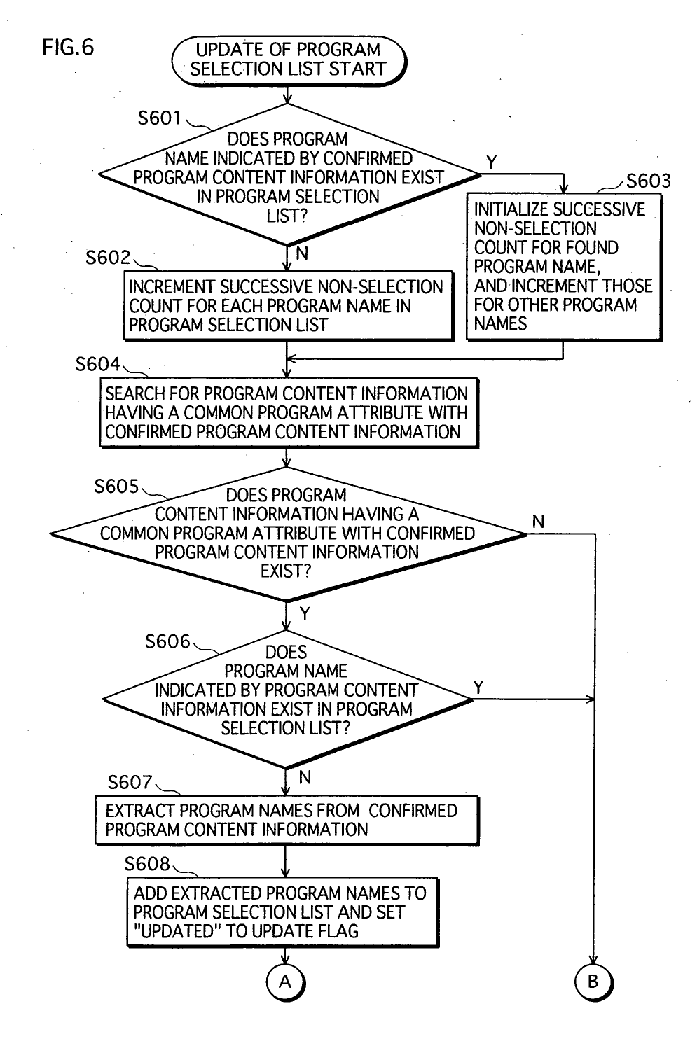

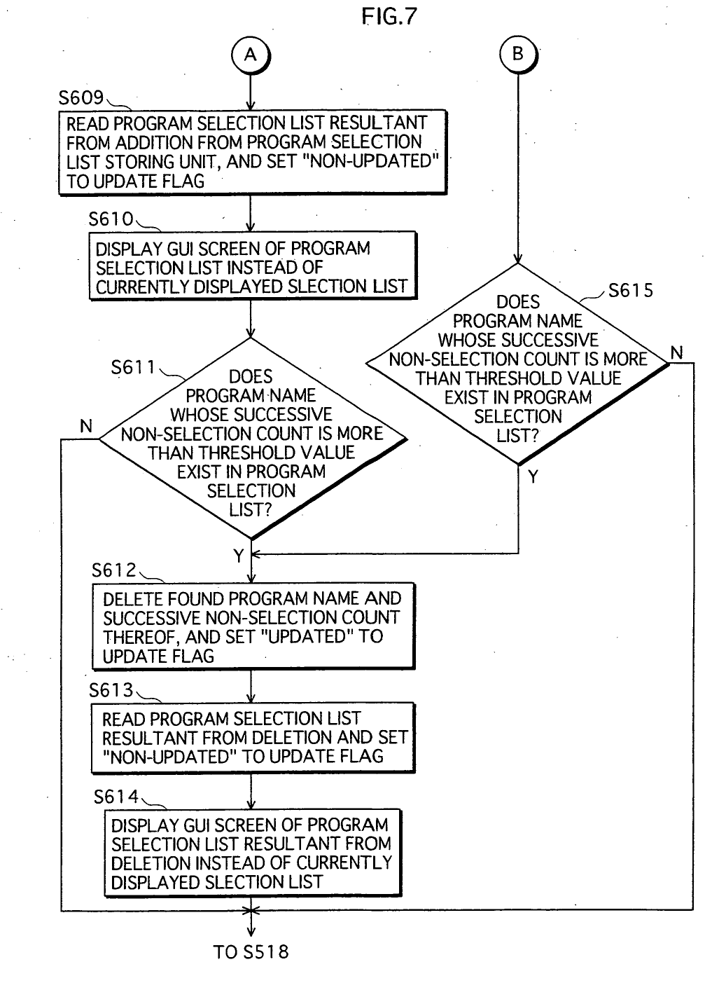

Next, the following describes a procedure for updating the program selection list performed by the program selection support device 100. FIG. 6 and FIG. 7 are flowcharts showing this procedure. The following describes the procedure with reference to FIG. 6 and FIG. 7.

The program guide managing unit 107 sets a selection confirmation flag corresponding to the time slot, the broadcast channel, the piece of program content information of the confirmed broadcast program so as to indicate “selection confirmed”, receives the program selection list from the program selection list storing unit 108, and judges whether the program name indicated by the confirmed program content information exists in the program selection list (Step S601). If such a program does not exist in the program selection list (Step S601: N), the program guide managing unit 107 increments the successive non-selection count of each program name by 1 (Step S602), searches for a piece of program content information having a common program attribute with the confirmed piece of the program content information (Step S604), and judges whether a piece of program content information having a common program attribute with the confirmed piece of program content information exists (Step S605).

If apiece of program content information having a common program attribute with the confirmed piece of program content information exists (Step S605: Y), the program guide managing unit 107 judges whether the program name indicated by the piece of the program content information having the common attribute exists in the program selection list by comparing the program name indicated by the piece of program content information having the common program attribute and the program names included in the program selection list (Step S606).

If the program name indicated by the piece of the program content information having the common attribute does not exist in the program selection list (Step S606: N), the program managing unit 107 extracts a program name from the confirmed piece of the program content information having the common program attribute (Step S607), adds the extracted program name into the program selection list stored in the program selection list storing unit 108, sets “0” to the successive non-selection count of the program name, and sets “updated”, to the update flag associated with the program selection list (Step S608).

If “updated” is set to the update flag, the program selection list managing unit 104 reads the program names in the program selection list as a result of the addition from the program selection list storing unit 108, then sets “non-updated” to the update flag, and outputs the program selection list to the display control unit 106 (Step S609).

The display control unit 106 generates a GUI screen of a selection list of broadcast program names based on the broadcast program names input from the program selection list managing unit 104, deletes the selection list currently displayed, and displays the GUI screen of the newly generated selection list on the display unit 105 (Step S610).

Next, the program guide managing unit 107 judges whether a program name whose successive non-selection count is more than the threshold value exists in the program selection list resultant from the addition (Step S611).

If a program name whose successive non-selection count is more than the threshold value exists in the program selection list (Step S611: Y), the program guide managing unit 107 deletes the broadcast program name and the successive non-selection count from the program selection list, stores the deleted program selection list in the program selection list storing unit 108, and sets “updated” to the update flag (Step S612).

Next, if “updated” is set to the update flag, the program selection list managing unit 104 reads the broadcast program names of the deleted program selection list from the program selection list storing unit 108, sets “non-updated” to the update flag, and outputs the deleted program selection list to the display control unit 106 (Step S613).

Next, the display control unit 106 generates a GUI screen of broadcast program names based on the broadcast program names input from the program selection list managing unit 104, deletes the currently displayed selection list, and displays the GUI screen of the newly generated selection list on the display unit 105 (Step S614). Then, the display control unit 106 performs Step S518.

In the case where a piece of program content information having a common program attribute does not exist in Step S605 (Step S605: N), and in the case where a broadcast program name indicated by the piece of the program content information having the common program attribute exists in the program selection list in Step S606 (Step S606: Y), the program guide managing unit 107 judges whether a broadcast program name whose successive non-selection count is more than the threshold value exists in the program selection list (Step S615).

If a broadcast program name whose successive non-selection count is more than the threshold value exists in the program selection list (Step S615: Y), the program guide managing unit 107 performs Step S612, and if a broadcast program name whose successive non-selection count is more than the threshold value does not exist in the program selection list (Step S615: N), the program guide managing unit 107 performs Step S518.

### Second Embodiment

In the first embodiment, a single program selection support device independently displays the program list and the program guide associated to each other. On the contrary, in the second embodiment, a plurality of program selection support devices are connected to each other via a network, and they cooperatively generates a program list and a program guide and display the program list and the program guide.

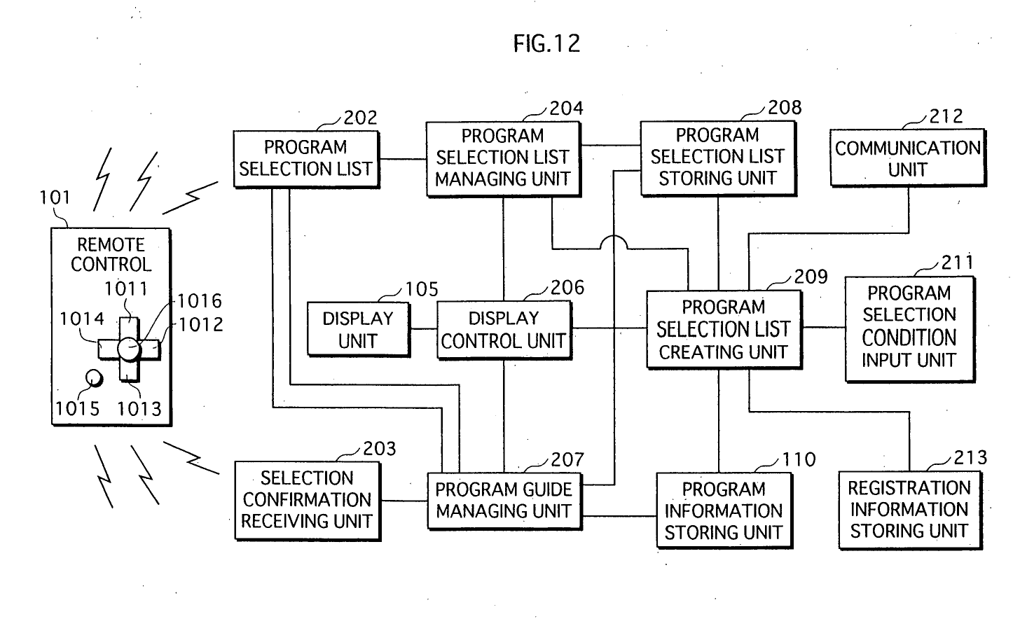

FIG. 12 is a functional block diagram showing a structure of a program selection support device 200 according to the second embodiment.

The program selection support device 200 includes a remote control 101, a program selection unit 202, a selection confirmation receiving unit 203, a program selection list managing unit 204, a display unit 105, a display control unit 206, a program guide managing unit 207, a program selection list storing unit 208, a program selection list creating unit 209, a program information storing unit 110, a program selection condition input unit 211, a communication unit 212, and a registration information storing unit 213.

Here, the same reference numbers are given to the same components as in the first embodiment and only the components different from the program selection support device 100 of the first embodiment are described next. Explanations of the other components are omitted here.

Note that each of the plurality of the external program selection support devices connected with the program selection support device 200 via a network includes the same components as those of the program selection support device 200.

The network may be the Internet or an intranet such as a LAN.

The program selection unit 202 has the following function in addition to the function of the program selection unit 102 of the first embodiment.

Upon receiving an instruction for starting up a complex program selection procedure which is described later from the remote control 101, the program selection unit 202 notifies the program selection list managing unit 204 and the program guide managing unit 207 of the instruction.

In accordance with an instruction for confirmation of the preprogramming for viewing or recording input by an operation of the selection confirmation key 1016 of the remote control 101, the selection confirmation receiving unit 203 notifies the program guide managing unit 207 of the time slot, the broadcast channel and the piece of the program content information of the broadcast program as to which the preprogramming has been confirmed.

The switching between the instruction for confirming the preprogramming for viewing and the instruction for confirming the preprogramming for recording is, for example, performed by operating the keys of the remote control 101 on the GUI screen.

The program selection list storing unit 208 stores an individual program selection list and an update flag in association with each other.

Here, the “individual program selection list” is a list for a specific user (identified by a user ID) of each of the program selection support device 200 and external program selection support devices connected with the program selection support device 200 via the network. The list includes a device ID of the program selection support device, a list of broadcast program names that can be selected, a status of preprogramming for viewing and recording for each of the broadcast program, and the successive non-selection count of the broadcast program, which are associated with each other.

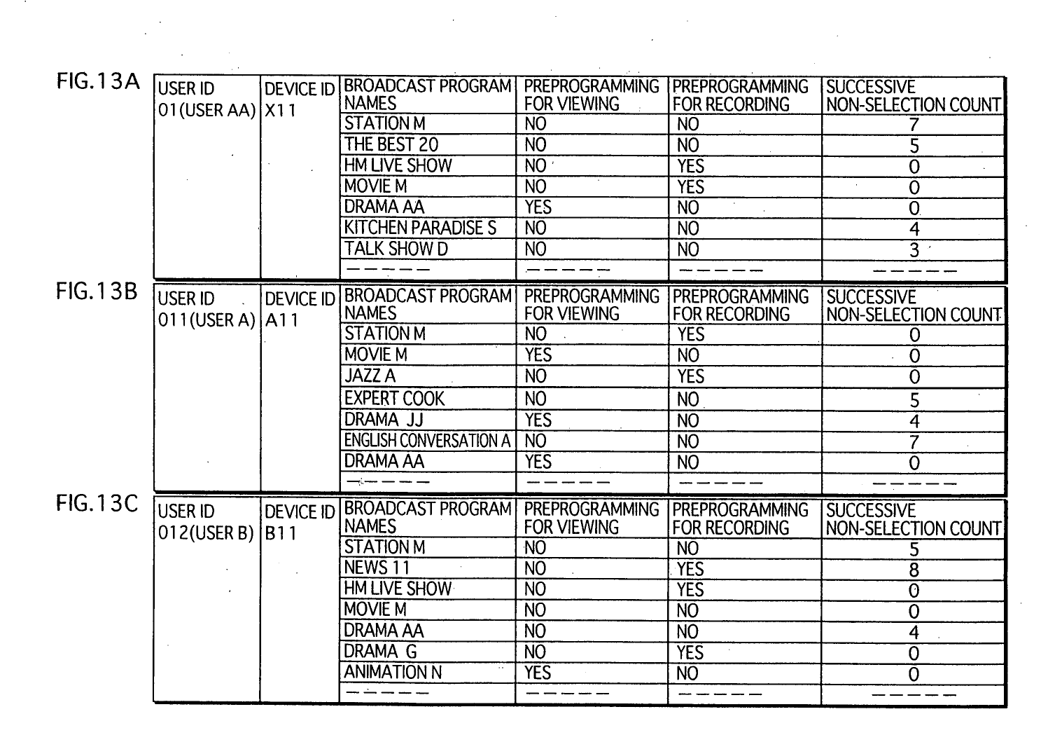

FIG. 13A to FIG. 13C show specific examples of the individual program selection list.

The program selection list storing unit 208 stores a threshold value of the successive non-selection count.

The program selection list storing unit 208 also stores, a complex program selection list described later and the update flag in association with each other.

The registration information storing unit 213 stores registration information and per-user registration group information.

Here, the “registration information” is information for registering, for each of the users of the program selection support device 200, users of an external program selection support device (hereinafter simply called “the external device”) who is allowed to exchange the information of the program selection list. More specifically, an ID (an IP address or an identifier) of the program selection support device 200 at a registration destination, a user ID of a user at the registration destination, an ID (an IP address or an identifier) of the external device at a registration source, a user ID of a user at the registration source, a registration source access-permitted group and a registration destination access-permitted group respectively designated by the user at the registration source and the user at the registration destination.

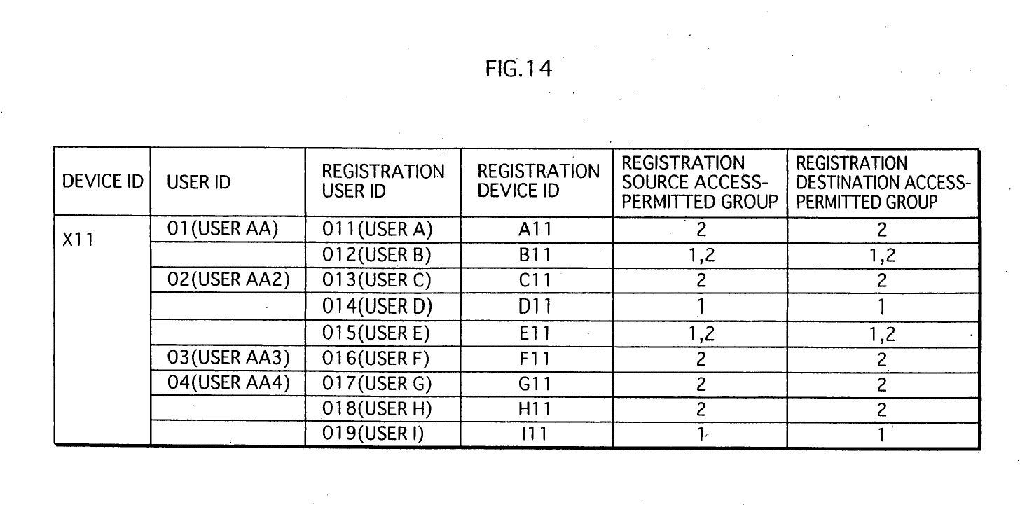

FIG. 14 is a specific example of the registration information. In FIG. 14, the “device ID” represents the ID of the program selection support device 200 at the registration destination. The “user ID” represents the user ID of a user at the registration destination. The “registration user ID” represents the user ID of a user at the registration source. The “registration device ID” represents the ID of the external device at the registration source.

According to the registration information in FIG. 14, regarding a user AA who has a user ID “01” and is a user of a device having a device ID “X11”, a user A having a user ID “011” and a user B having a user ID “012” are registered as users who are permitted to exchange the individual program selection list with the user AA.

The “registration source access-permitted group” is registered for each user of the registration source device. The user of the registration destination device is allowed to access the individual program selection list of each user in this group.

In the example of the registration information shown in FIG. 14, the user AA who has a user ID “01” and is a user of the device having the device ID “X11” is permitted by the user A of the registration source to access a registration group 2, and also permitted by the user B of another registration source to access registration groups 1 and 2.

The “registration destination access-permitted group” is registered for each user of the registration destination device. The user of the registration source device is allowed to access the individual program selection list of each user in this group.

In the example of the registration information shown in FIG. 14, the user AA, whose has a user ID “01” and is a user of the device having the device ID “X11”, permits the user A of the registration source to access a registration group 2, and also permits the user B of another registration source device to access registration groups 1 and 2.

Here, “per-user registration group information” is a group classification table used for classifying the users of the registration source device into groups. More specifically, the per-user registration group information is information showing a relation among the ID of the program selection support device 200 at the registration destination, the user ID at the registration destination, the registration group, and the list specifying information (the user ID, the device ID of the program selection support device, and the registration source access-permitted group) for specifying the individual program selection list of each user at the destination belonging to the registration group.

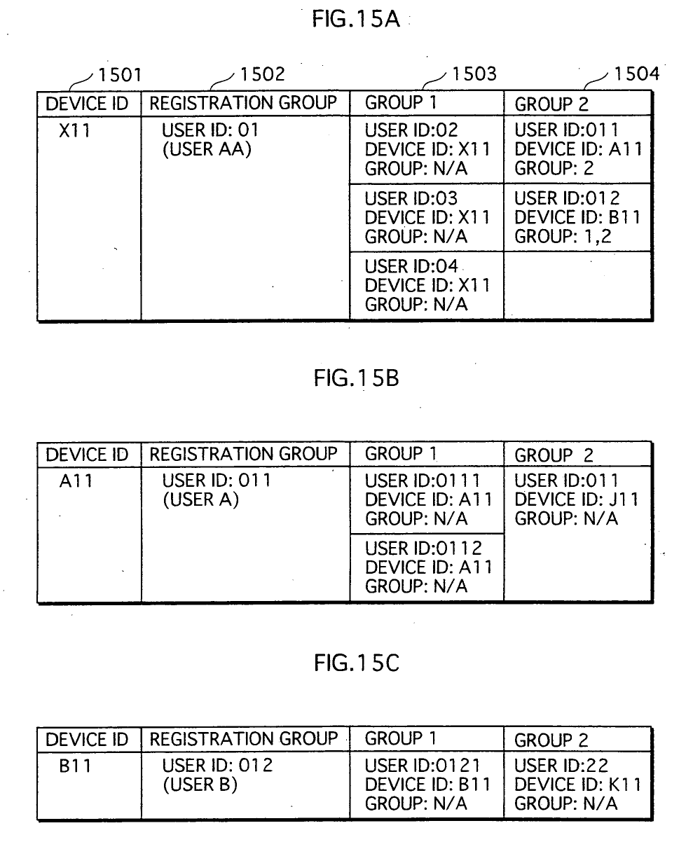

FIG. 15 shows a specific example of the per-user registration group information. In FIG. 15A, the sign 1501 indicates a device ID of the program selection support device as the registration destination device, the sign 1502 indicates a user ID of a user of the registration destination device, a sign 1503 indicates list specifying information belonging to a registration group 1, and a sign 1504 indicates list specifying information belonging to a registration group 2. The user ID indicated by each piece of the list specifying information is the user ID of the user of the registration source, and the device ID indicated by each piece of the list specifying information is the program selection support device ID at the registration source, and the group indicated by each piece of the list specifying information is the registration source access-permitted group.

The per-user registration group information in FIG. 15 shows that a registration group 1 and a registration group 2 are registered as registration groups that the user AA having the user ID “01” can access or can permit access. The group 1 includes users respectively having user IDs “02” to “04”, who are the user of the program selection support device X11 as the user AA is. The group 2 includes the users of the external devices (A11 and B11), and groups that are permitted by each of these users to access to the program selection list of these users.

In the example of FIG. 14, regarding the user AA, a registration group 2 included in the per-user registration group information shown in FIG. 15B and registration groups 1 and 2 included in the per-user registration group information shown in FIG. 15C are registered as the registration source access-permitted groups.

The program selection list creating unit 209 performs operations for creating a program selection list, registering a user and registering a registration group.

### Operations for Creating Program Selection List

### 1. Creation of Internal User Program List

The program selection list creating unit 209 specifies, from pieces of the broadcast program information stored in the program information storing unit 110, a piece of program content information that satisfies the selection condition based on the user ID and the selection condition for the broadcast program (e.g. the range of the time slot, the range of the broadcast channel, an attribute such as the genre name) designated by the user with the program selection condition instruction input from the program selection condition input unit 211. Then, the program selection list creating unit 209 creates an individual program selection list based on a broadcast program name included in the specified piece of the program content information, and stores the created list in the program selection list storing unit 208.

### 2. Acquisition of External User Program List

The program selection list creating unit 209 reads the per-user registration group information relating to the user ID from the program selection list storing unit 208, based on the user ID and the registration group designated by the user with the registration group program selection list creation instruction input from the program m selection condition input unit 211. Then, the program selection list creating unit 209 specifies pairs of a user ID and an external device ID belonging to the specified registration group, with reference to the read per-user registration group information. After that, the program selection list creating unit 209 connects to the specified external device via the communication unit 212, acquires an individual program selection list and per-user registration group information relating to the specified pair from the external device, and stores the individual program selection list and the per-user registration group information in the registration information storing unit 213.

Furthermore, the program selection list creating unit 209 notifies the external device of the registration source access-permitted group relating to the specified pair. Then, the program selection list creating unit 209 acquires the individual program selection list relating to the pair of the user ID and the external device ID belonging to the registration source access-permitted group, and stores the individual program selection list in the program selection list storing unit 208.

More specifically, the external device specifies a piece of the per-user registration group information associated with the specified group, with reference to the per-user registration group information stored in the registration information storing unit of the external device. Then, the external device selects a pair of a user ID and an external device belonging to the registration group as the registration source access-permitted group, acquires an individual program selection list corresponding to the selected pair from the individual program selection lists stored in the external device, and transmits the selected the list to the program selection list creating unit 209.

In the case where there already is the registration source access-permitted group relating to the selected pair in the per-user group information, the external device refers to the per-user registration group information associated with the pair to acquire the individual program selection list of each pair belonging to the registration source access-permitted group in the same manner as described above, and transmits the list to the program selection list creating unit 209.

The acquisition of the individual program selection list from the external device may be performed without a registration group program selection list creating instruction input by the user. The program selection list creating unit 209 may periodically try to acquire the individual program selection list from all the external devices registered in the per-user registration group information, and updates the individual program selection list based on the external device whenever necessary by recoding the individual program selection list successfully acquired.

### 3. Creation of Complex Program Selection List

The program selection list creating unit 209 reads a piece of per-user registration group information associated with the specified user ID from the registration information storing unit 214, based on the user ID, the ID of the program selection support device, and the registration group specified by the complex program selection list startup instruction input by the user from the program selection list managing unit 204. Then, the program selection list creating unit 209 refers to the per-user registration group information and selects a pair of an external device ID and a user ID belonging to the specified registration group and the registration source access-permitted group specified as to the pair, and acquires the individual program selection list corresponding to the pair from the program selection list storing unit 208. Furthermore, the program selection list creating unit 209 acquires the per-user registration group information, and specifies a pair of a registration source user ID and a registration source external device belonging to the registration group included in the selected registration source access-permitted group in the per-user registration group. The program selection list creating unit 209 acquires an individual program selection list corresponding to the specified pair from the program selection list storing unit 208, and further acquires an individual program selection list corresponding to the specified pair of the user ID and the program selection support device from the program selection list storing unit 208. Finally, the program selection list creating unit 209 creates a complex program selection list by combining all the acquired individual program selection lists, and stores the complex program selection list in the program selection list storing unit 208.

More specifically, the complex program selection list is created in accordance with the following procedure.

The program selection list creating unit 209 creates a base list by adding preprogrammer specifying information to the individual program selection list associated with the pair of the user ID and the program selection support device Id specified by the instruction for creating the complex program selection list. Here, the preprogrammer specifying information is information for specifying a user who has performed the preprogramming in the case where preprogramming for viewing and recording is included in the individual program selection list. More specifically, the preprogrammer specifying information includes a user ID and a device ID thereof, or only a user ID. The program selection list creating unit 209 compares the base list with an individual program selection list (hereinafter called “a non-base list”) of another pair. If a program name not included in the base list is included in the non-base list, the program selection list creating unit 209 adds the program name to the base list, and sets “0” to the successive non-selection count of corresponding to this program name. Furthermore, the program selection list creating unit 209 judges whether preprogramming for recording or preprogramming for recording as to the broadcast program having the added program name exists based on the non-base list. If exists, the program selection list creating unit 209 records, in the base list, “preprogram information” indicating the existence of the program and the preprogrammer specifying information of the preprogrammer of the non-base list. If the program name of the non-base list is included in the base list, the program selection list creating unit 209 does not add the program name into the base list, and further judges whether preprogramming for recording or preprogramming for recording as to the broadcast program having the added program name exists based on the non-base list. If exists, the program selection list creating unit 209 records, in the base list, “preprogram information” indicating the existence of the program and the preprogrammer specifying information of the preprogrammer of the non-base list.

The above-described procedure is repeated for each of the broadcast programs included in the acquired non-base lists to create the complex program selection list, and the created complex program selection list is stored in the program selection list storing unit 208. Then, “updated” is set to the corresponding update flag.

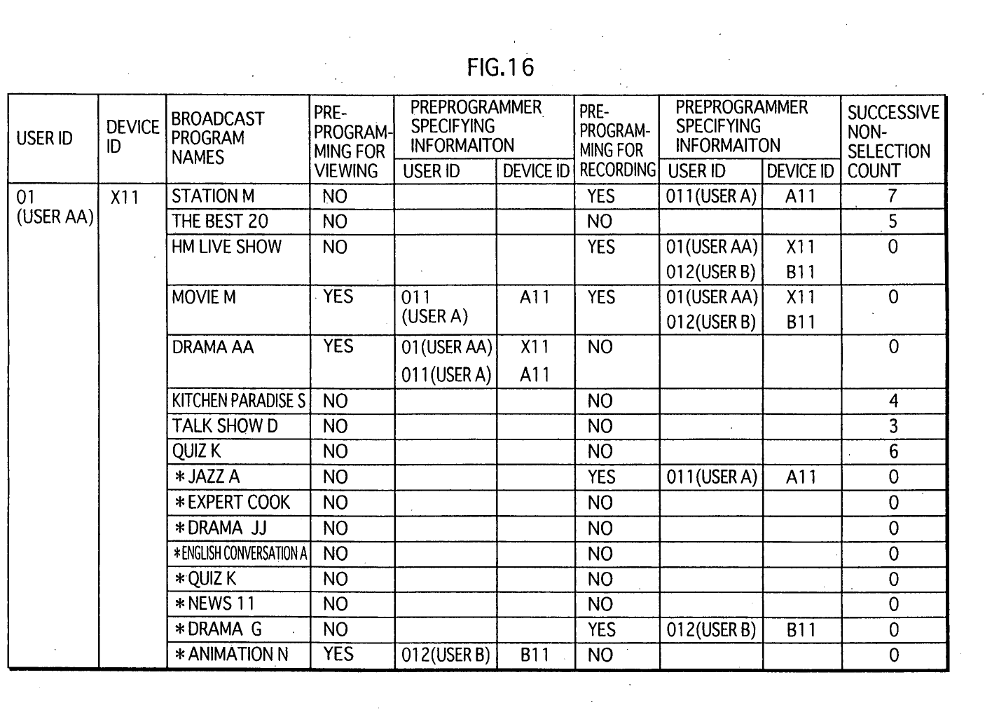

FIG. 13 shows a specific example of a complex program selection list created by the above-described procedure. The complex program selection list shown in FIG. 16 is a specific example created by combining the individual program selection lists shown in FIG. 13A, FIG. 13B and FIG. 13C, using the FIG. 13A as the base list. The sign “*” indicates a program name added to the base list.

### User Registration

Every time the program selection list creating unit 209 receives a user registration request from an external device via the communication unit 212, the program selection list creating unit 209 creates a piece of registration information, based on the user IDs of the users of the registration destination and the registration source, the ID of the external device and the registration source access-permitted group, which are specified by the user registration request, and the registration destination access-permitted group input by the user from the program selection condition input unit 211 of the program selection support device 200, to which the user of the registration source belongs, via the remote control 101. Then, the program selection list creating unit 209 records the registration information in the registration information storing unit 213.

### Registration Group Registration

After creating the registration information, the program selection list creating unit 209 reads, from the registration information storing unit 213, the per-user registration information of the registration destination user ID specified by the registration request relating to the created registration information. Then, the program selection list creating unit 209 receives a specification of a registration group in which the registration source user ID is to be registered from the user via the program selection condition input unit 211, and registers the user ID of the registration source and the ID of external device of the registration source in the registration group specified n the read per-user registration group information. Finally, the program selection list creating unit 209 replaces the old per-user registration group information with the newly registered per-user registration group information and records the new per-user registration group information in the registration information storing unit 213.

In this embodiment, it is assumed that the registration group is specified by the registration destination user based on the user attributes of the users of the registration source such that users having the same attribute is classified in the same group. For example, users belonging to the same company are classified in the first group, users having the same hobby are classified in the second group, and users as neighbors are classified in the third group.

Alternatively, the registration destination user may previously record, in the registration information storing unit 213, a registration table indicating a relation among a pair of the user ID of the registration destination user and the ID of the program selection support device that the user belongs to, the ID of the registration source user to be registered, and the registration group. When the user registration request is transmitted from the registration source user, the program selection list creating unit 209 may read the per-user registration group information of the registration destination user ID specified in the user registration request and the registration table, and specify a registration group associated with the registration source user ID with reference to the registration table. Then, the program selection list creating unit 209 may register the user ID and the external device ID of the registration source in a group corresponding to the specified registration group in the read per-user registration group information.

The program selection condition input unit 211 receives a program selection condition instruction, a registration group program selection list creating instruction, an input of the registration destination access-permitted group and so on from the user via the remote control 201, and outputs the received information to the program selection list creating unit 209.

The communication unit 212 establishes connection with external device in accordance with an instruction from the program selection list creating unit 209.

Specifically, the communication unit 212 receives an ID of an external device that is a connection destination from the program selection list creating unit 209. If the received ID is the IP address of the external device, the communication unit 212 connects with the external device using the IP address. If the received ID is an identifier, the communication unit 212 connects with an external server that manages a relation between identifiers of the external devices and the IP addresses given to the external devices. Then, the communication unit 212 obtains the IP address of the external device from the external server, and establishes the connection with the external device.

The program selection list 204 has the functions of the program selection list managing unit 104 according to the first embodiment. In addition, the program selection list 204 monitors the update flag indicating whether the complex program selection list has been updated. If receiving notification of an instruction for starting up the complex program selection procedure from the program selection list 202, the program selection list managing unit 204 notifies the program selection list creating unit 209 of the instruction. If the program selection list creating unit 209 or the program guide managing unit 207 creates or update the complex program selection list, and the update flag associated with the complex program selection list stored in the complex program selection list storing unit 208 indicates “updated”, the program selection list 204 reads the program names included in the complex program selection list from the program selection list storing unit 208, and outputs the names to the display control unit 206.

Here, it is assumed that when the complex program selection procedure of the program selection support device 200 is sated up and it is in the initial status, the update flag indicates “updated”.

The program guide managing unit 207 has a function of the program guide managing unit 107 according to the first embodiment. In addition, the program guide managing unit 207 performs procedure for creating a full program guide that corresponds to the complex program selection list (hereinafter called the “correspondence program guide”) and an on-screen correspondence program guide, and performs update of the complex program selection list in the same manner as the program guide managing unit 107 performs the program selection list.

### Creation of Correspondence Program Guide

If receiving a notification of the instruction for starting up the complex program selection procedure from the program selection unit 202, the program guide managing unit 207 creates a correspondence program guide based on the pieces of program information stored in the program information storing unit 110 and the complex program selection list stored in the program selection list storing unit 208, and stores the created correspondence program guide in the program information storing unit 110.

Here, the “correspondence program guide” is a full program guide created by adding the preprogram information indicating that viewing or recording has been preprogrammed and the preprogrammer specifying information (e.g. a user ID and an ID of a device to which the user belongs, and a user name) that specifies the user who has preprogrammed the viewing or the recording to the program content information of the program, viewing or recording of which is preprogrammed in the complex program selection list.

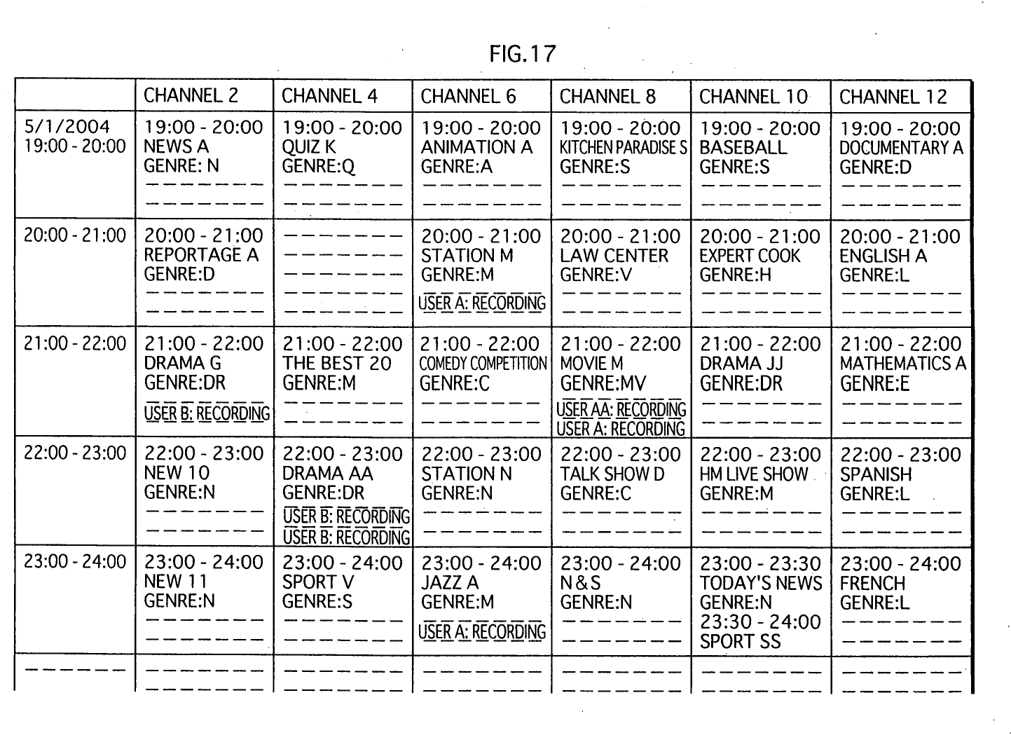

FIG. 17 is a specific example of the correspondence program guide.

### Creation of On-Screen Correspondence Program Guide

Upon receiving notification of the candidate program name from the display control unit 206, the program guide managing unit 207 specifies a piece of the program content information including the candidate program name in the created correspondence program guide, and creates an on-screen program guide (hereinafter called the “on-screen correspondence program guide”) by extracting a program guide constituted of time slots and broadcast channels in a predetermined range centered around the time slot and the broadcast channel with which the program content information is associated.

The program guide managing unit 207 also updates the complex program selection list in the same manner as the program guide selection list update procedure in the first embodiment.

The display control unit 206 has the following functions in addition to the function of the display control unit 106 according to the first embodiment.

If the complex program selection procedure is started up, the display control unit 206 generates a GUI screen of the complex program selection list based on the broadcast program names included in the complex program selection list input from the program selection list managing unit 204, and displays the GUI screen on the display unit 105. If a GUI screen of the complex program selection list is already displayed on the display unit 105, the display control unit 206 deletes the old complex program selection list, and displays newly generated GUI screen of the complex program selection list on the display unit 105. Further, if receiving notification of the candidate program name from the program selection list managing unit 204, the display control unit 206 notifies the program guide managing unit 207 of the candidate program name, and highlights the candidate program name included in the selection list displayed on the display unit 105.

The display control unit 206 generates a GUI screen of the on-screen correspondence program guide based on the on-screen correspondence program guide created by the program guide managing unit 207, and displays the GUI screen on the display unit 105. Then, the display control unit 206 displays the cursor on the piece of the program content information including the candidate program name among the pieces of the program content information displayed in the on-screen correspondence program guide. FIG. 18 is a specific example of the complex program selection list and the on-screen correspondence program guide displayed on the display unit 105. A sign 1801 in FIG. 18 indicates a specific example of the complex program selection list. The example indicated by the sign 1801 shows that the candidate program name “Station M” is highlighted. A sign 1802 in FIG. 18 indicates a specific example of the on-screen correspondence program guide. The example indicated by the sign 1802 shows that the cursor (the frame) is displayed around the program content information of the “station M” selected as the candidate program in 1801. In this example, the preprogram information and the preprogrammer specifying information (a user name in this example) are displayed in the program content information of each of “drama G”, “station M” “movie M”, which are preprogrammed to be recorded.

### <Operations>

The following describes operations performed by the program selection support device 200 for selecting a program using the complex program selection list.

The operations include operations for creating the complex program selection list, operations for complex program selection, and operations for updating the complex program selection list.

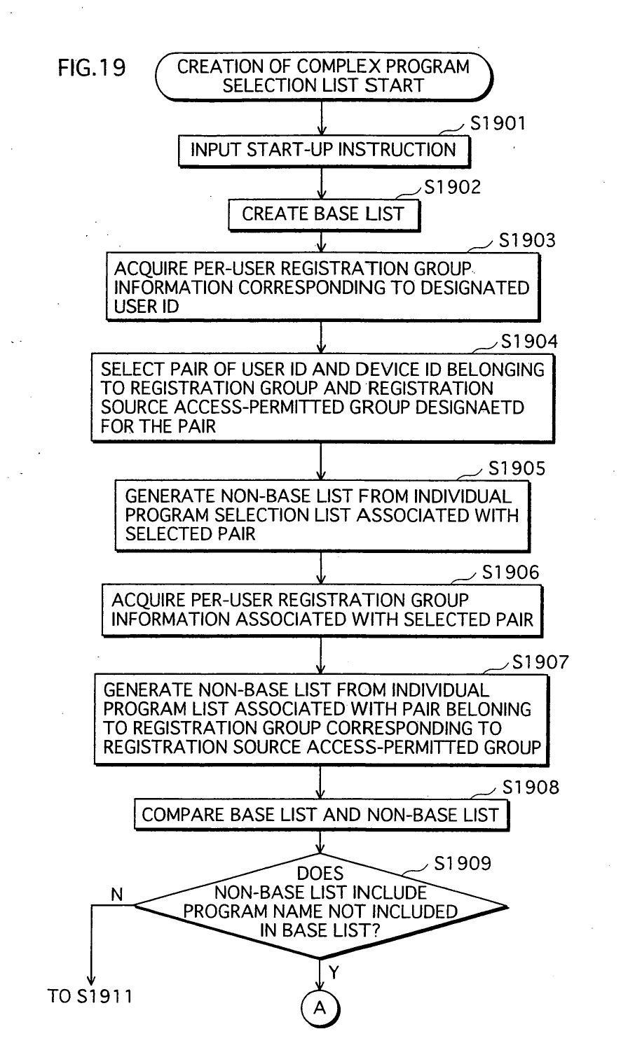

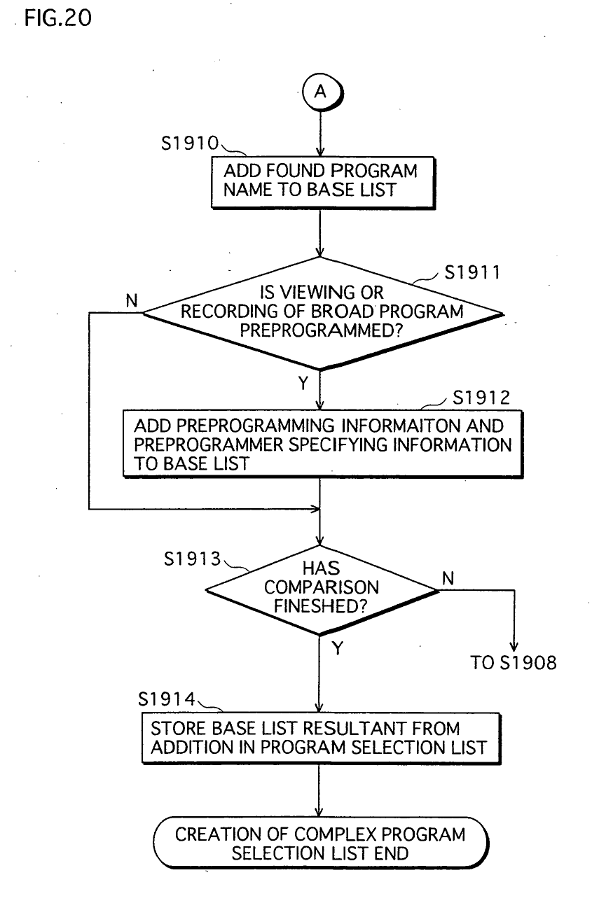

Firstly, the operations for creating the complex program selection list performed by the program selection list creating unit 209, in comparison with the specific examples shown in FIG. 13 and FIG. 15. FIG. 19 and FIG. 20 are flowcharts illustrating the operations above.

Upon receiving an instruction for starting up the complex program selection procedure input from the program selection condition input unit 211 (Step S1901), the program selection list creating unit 209 acquires an individual program selection list associated with the pair of the user ID and the program selection support device ID designated by the startup instruction from the program selection list storing unit 208, and creates a base list by adding the preprogrammer information to the acquired individual program selection list (Step S1902). For example, if a user ID “01” and a program selection support device ID “X11” are designated by the startup instruction, the program selection creating unit 209 acquires the individual program selection list of the user AA shown in FIG. 13A, and adds the preprogrammer specifying information that specifies the user AA to the acquired individual program selection list to create a base list.

Furthermore, the program selection list creating unit 209 acquires the per-user registration group information corresponding to the pair of the designated user ID and program selection support device ID from the registration information storing unit 213 (Step S1903). In this way, if “01” is designated as the user ID and “X11” is designated as the program selection support device ID, the program selection list creating unit 209 acquires the per-user registration group of the user AA shown in FIG. 15.

Furthermore, the program selection list creating unit 209 refers to the acquired per-user registration group information, and selects the pair of the external device ID and the user ID belonging to the registration group designated by the start up instruction, and the registration source access-permitted group designated for the pair (Step S1904). Then, the program selection list creating unit 209 acquires the individual program selection list associated with the selected pair from the program selection list storing unit 208, and creates anon-base list by adding the preprogrammer specifying information to the acquired individual program selection list (Step S1905). For example, if the registration group 2 is designated by the startup instruction, the program selection list creating unit 209 selects the registration source access-permitted group 2, which is designated for the pair of the external device ID “A11” and the user ID “011” belonging to the registration group 2 and the registration source access-permitted group 1 and 2, which are designated for the pair of the external device ID “B11” and the user ID “012” belonging to the registration group 2 as well, with reference to the per-user registration group information of the user AA shown in FIG. 15. Then, the program selection list creating unit 209 acquires the individual program selection lists of the users A and B shown in FIG. 15B and FIG. 15C, respectively associated with the pair of the external device ID “A11” and the user ID “011” and the pair of the external device ID “B11” and the user ID “012”, and creates non-base lists by adding the preprogrammer information to each of the acquired individual program selection lists.

The program selection list creating unit 209 acquires pieces of the per-user registration group information respectively associated with the selected pairs from the registration information storing unit 213 (Step S1906). Then, the program selection list creating unit 209 acquires the individual program selection list associated with the pair of the external device ID and the user ID belonging to the registration group corresponding to the registration source access-permitted group designated for the pair associated with the acquired per-user registration group information from the program selection list storing unit 208, and create a non-base list by adding the preprogrammer specifying information to the acquired individual program selection list (Step S1907). In the above-described manner, the program selection list creating unit 209 acquires the pieces of the per-user registration group information which are respectively shown in FIG. 15B and FIG. 15C and associated with the pair of the external device ID “A11” and the user ID “011” and the pair of the external device ID “B11” and the user ID “012”, from the registration information storing unit 213. Regarding the per-user registration group information shown in FIG. 15B, the program selection list creating unit 209 selects the pair of the external device ID “J11” and the user ID “011” belonging to the registration source access-permitted group 2. Regarding the per-user registration group information shown in FIG. 15C, the program selection list creating unit 209 selects the pair of the device ID “B11” and the user ID “0121” and the pair of the external device ID “K11” and the user ID “22” respectively belonging to the registration source access-permitted groups 1 and 2. Then, the program selection list creating unit 209 acquires the individual program selection lists respectively associated with the selected pairs from the program selection list storing unit 208, and creates a non-base list by adding the preprogrammer specifying information to the acquired individual program selection lists.

Next, the program selection list creating unit 209 compares the created base list and each of the created non-base lists (Step S1908), and judges whether a broadcast program name not included in the base list is included in any of the non-base lists (Step S1909). If included (Step S1909: Y), the program selection list creating unit 209 adds the program name to the base list (Step S1910), set “0” to the successive non-selection count corresponding to the added broadcast program name. Furthermore, the program selection list creating unit 209 judges whether preprogramming for viewing or preprogramming for recording of the program whose program name is added exists, based on the non-base lists (Step S1911). If such preprogramming exists (Step S1911: Y), the program selection list creating unit 209 adds the preprogramming information and the preprogrammer specifying information to the base list (Step S1912). Then, the program selection list creating unit 209 judges whether the comparison with the base list has been finished for every non-base list (Step S1913). If the comparison has been finished (Step S1913: Y), the program selection list creating unit 209 stores the base list into which the program name is added in the program selection list storing unit 208 (Step S1914). If the comparison has no been finished (Step S1913: N), the program selection list creating unit 209 repeats the processing of Step S1908 as to the next non-base list.

If judging negatively in Step S1909 (Step S1909: N), the program selection list creating unit 209 does not adds the program name in the base list, and performs the processing of Step S1911 as to the broadcast program having the program name.

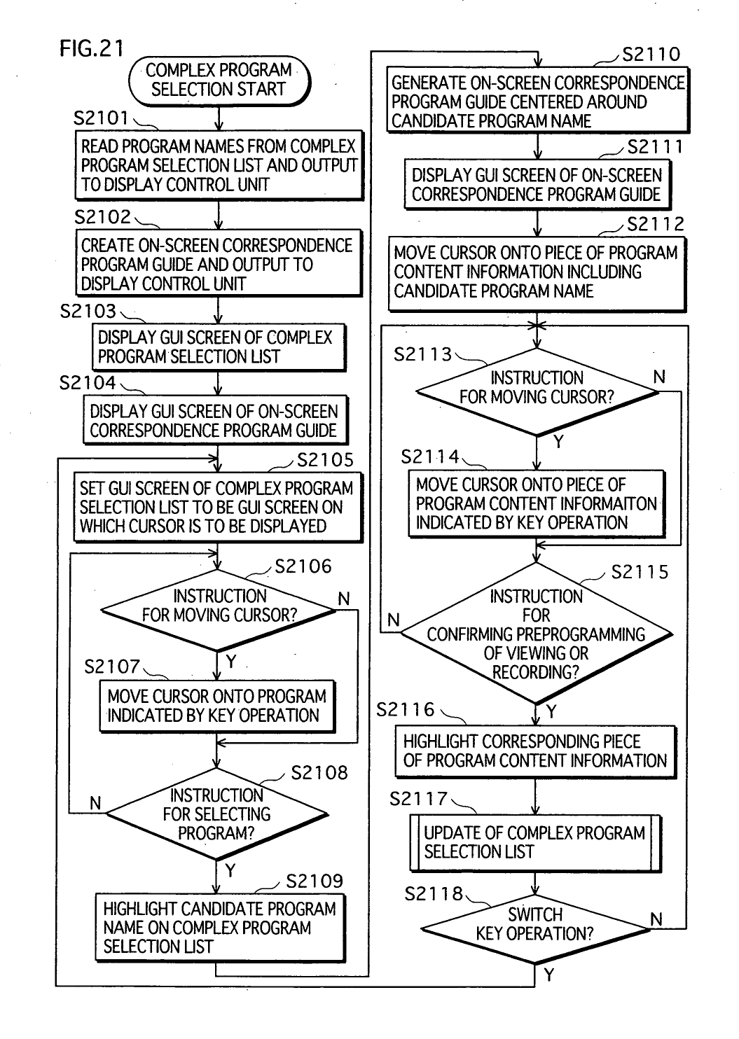

Next, the following describes the operations for complex program selection performed by the program selection support device 200. FIG. 21 is a flowchart showing the operations.

When the program selection list creating unit 209 finishes the creation of the complex program selection list, the program selection list managing unit 204 reads the broadcast program names from the complex program selection list stored in the program selection list storing unit 208, and outputs the broadcast program names to the display control unit 206 (Step S2101).

Furthermore, the program guide managing unit 207 creates a correspondence program guide based on each piece of the broadcast program information stored in the program information storing unit 110 and the complex program selection list stored in the program selection list storing unit 208, and specifies, in the correspondence program guide, a predetermined program name (e.g. the first program name, hereinafter called “initial program name”) included in the complex program selection guide. Furthermore, the program guide managing unit 207 creates the on-screen correspondence program guide by extracting, from the correspondence program guide, a program guide constituted of time slots and broadcast channels in a predetermined range centered around the time slot and the broadcast channel with which the program content information is associated, and outputs the on-screen correspondence program guide to the display control unit 206 (Step S2102).

The display control unit 206 generates a GUI screen of a complex program selection list based on the program names included in the complex program selection list input by the program selection managing unit 204, and displays the GUI screen on the display unit 105 (Step S2103). Then, the display control unit 206 highlights the initial program name in the complex program selection list displayed on the display unit 105. Furthermore, the display control unit 206 generates a GUI screen of an on-screen correspondence program guide based on the on-screen correspondence program guide input by the program guide managing unit 207, and displays the GUI screen on the display unit 105 (Step S2104). After displaying the cursor on a piece of program content information including the broadcast program name highlighted in the complex program selection list, the display-control unit 206 sets the GUI screen on which the cursor is to be displayed as the GUI screen of the complex program selection list (Step S2105). If receiving an instruction for moving the cursor given with an operation of any of the up key 1011 and down key 1013 (Step S2106: Y), the display control unit moves the cursor on the GUI screen of the complex program selection list in the instructed direction, onto the broadcast program name (Step S2107), and judges whether the program selection instruction is input based on whether notification of a candidate program is transmitted from the program selection list managing unit 204 (Step S2108).

If the program selection instruction is input (Step S2108: Y), the display control unit 206 notifies the program guide managing unit 207 of the candidate program name, and highlights the candidate program name in the selection list displayed on the display unit 105 as indicated by the sign 1801 in FIG. 18 (Step S2109).

Next, upon receiving the notification of the candidate program name from the display control unit 206, the program guide managing unit 207 specifies a piece of program content information including the candidate program name in the correspondence program guide stored in the program information storing unit 110. Furthermore, the program guide managing unit 207 generates the on-screen correspondence program guide by extracting, from the correspondence program guide, a program guide constituted of time slots and the broadcast channels in a predetermined range centered around the time slot and the broadcast channel associated with the specified piece of the program content information (Step S2110), and displays the on-screen correspondence program guide on the display control unit 206.

Next, the display control unit 206 generates a GUI screen of the on-screen correspondence program guide based on the on-screen correspondence program guide input from the program guide managing unit 207, and displays the GUI screen on the display unit 105 (Step S2111). Then, as the sign 1802 in FIG. 18 indicates, the display control unit 206 switches the target of cursor display to the piece of program content information including the candidate program name in the program content information displayed in the on-screen correspondence program guide (Step S2112). If receiving an instruction for moving the cursor given with an operation of any of the up key 1011 and down key 1013 (Step S2113: Y), the display control unit moves the cursor on the GUI screen of the on-screen correspondence program guide in the instructed direction, onto the piece of the program content information (Step S2114), and judges whether the preprogramming confirmation instruction for viewing or recording is input based on whether notification of the time slot, the broadcast channel the piece of the program content information of the broadcast program preprogrammed for viewing or recording is transmitted from the program guide managing unit 207 (Step S2115).

If the preprogramming instruction for viewing or recording is input (Step S2115: Y), the display control unit 206 highlights the notified piece of the program content information in the GUI screen of the on-screen correspondence program guide displayed on the display unit 105 (Step S2116). Then, the display control unit 206 notifies the program selection list managing unit 204 of the broadcast program name of the piece the program content information as to which the preprogramming instruction of viewing or recording is input to the program selection list managing unit 204, and has the program selection list managing unit 204 perform updating of the complex program selection list, which is described later (Step S2117). If an instruction for switching the target the GUI screen for displaying the cursor is input given with the operation of the switch key 1015 (Step S2118: Y), the display control unit 206 performs the processing of Step S2105. If such the switching instruction is not input, the display-control unit 206 performs the processing of Step S2113.

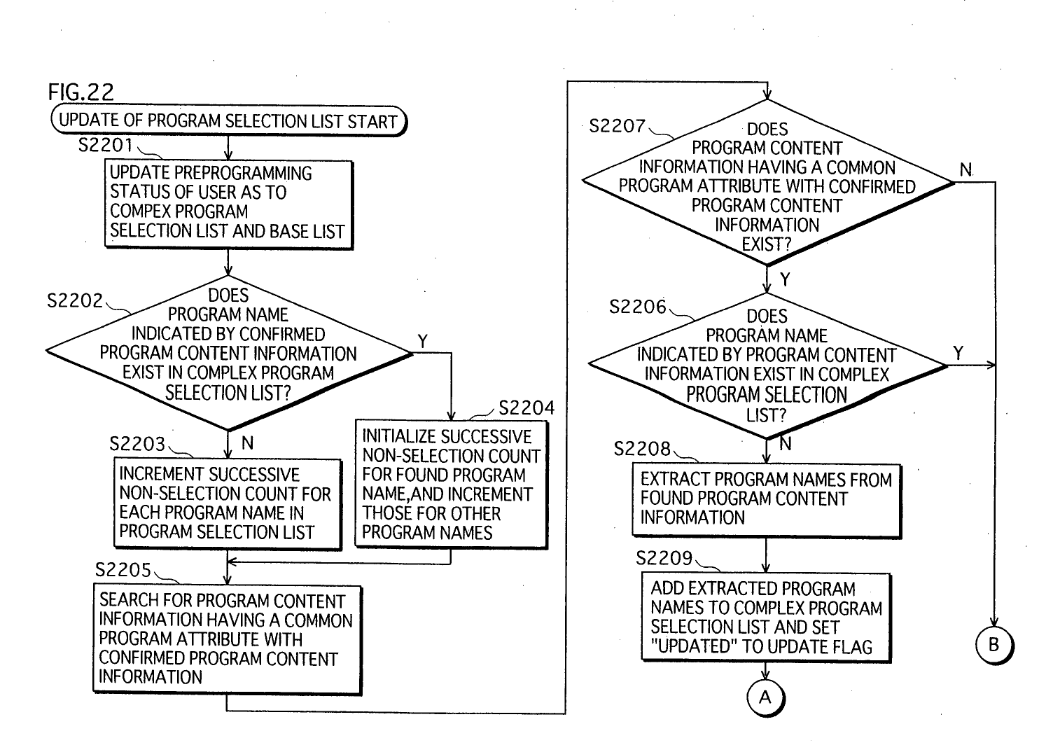

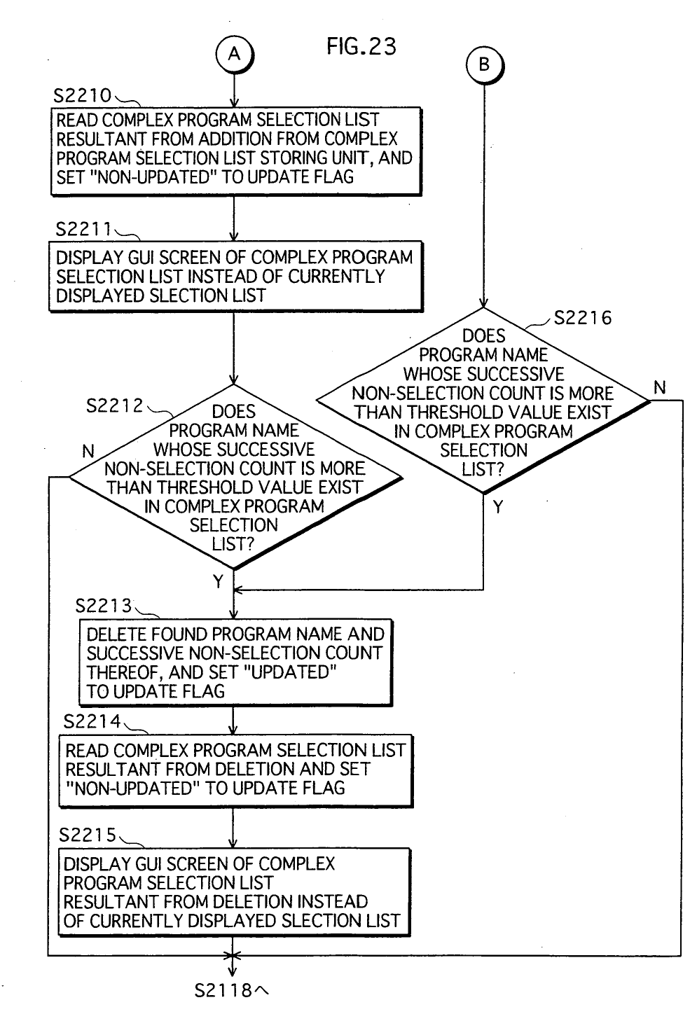

Next, the following describes the operations for updating the program selection list performed by the program selection support device 200. FIG. 22 and FIG. 23 are flowcharts showing the operations.

Upon receiving the notification of the broadcast program name as to which the preprogramming for viewing or recording is confirmed from the display control unit 206, the program selection list managing unit 204 updates, as to the complex program selection list and the base list thereof, the preprogramming status of the user (the original user of each selection list) corresponding to the notified program name (Step S2201). As to the complex program selection list, the program selection list managing unit 204 updates the preprogrammer specifying information as well.

Steps following the Step S2201 are the same as the operations for updating the program selection list, described in FIG. 6 and FIG. 7, where the “program selection list” should read “complex program selection list”. Therefore, the explanations are omitted here.

### <Supplementary Explanations>

The program selection support devices 100 and 200 according to the present invention are described above based on the first and second embodiments respectively. However, the present invention is not limited to those embodiments.

(1) For example, in Step S516 of the program selection procedure of the first embodiment shown in FIG. 5, upon receiving the notification of the piece of the program content information selected and confirmed by the program guide managing unit 107, the display control unit 106 highlights the notified piece of the program content information in the GUI screen of the on-screen program guide displayed on the display unit 105. However, in addition to this, if the program name indicated by the piece of the program content information is included in the program selection list in step S601 of FIG. 6 (Step S601: Y), the program guide managing unit 107 may delete the program name and the successive non-selection count thereof from the program selection list, and the display control unit 106 may display the program names in the program selection list resultant from the deletion on the display unit 105.

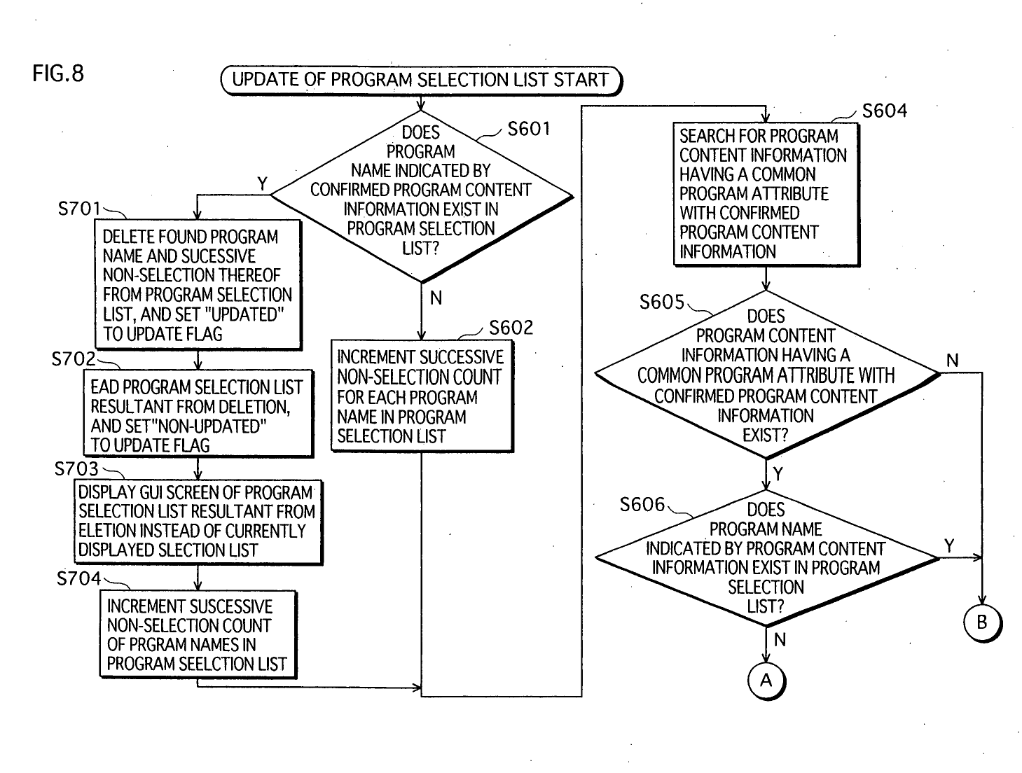

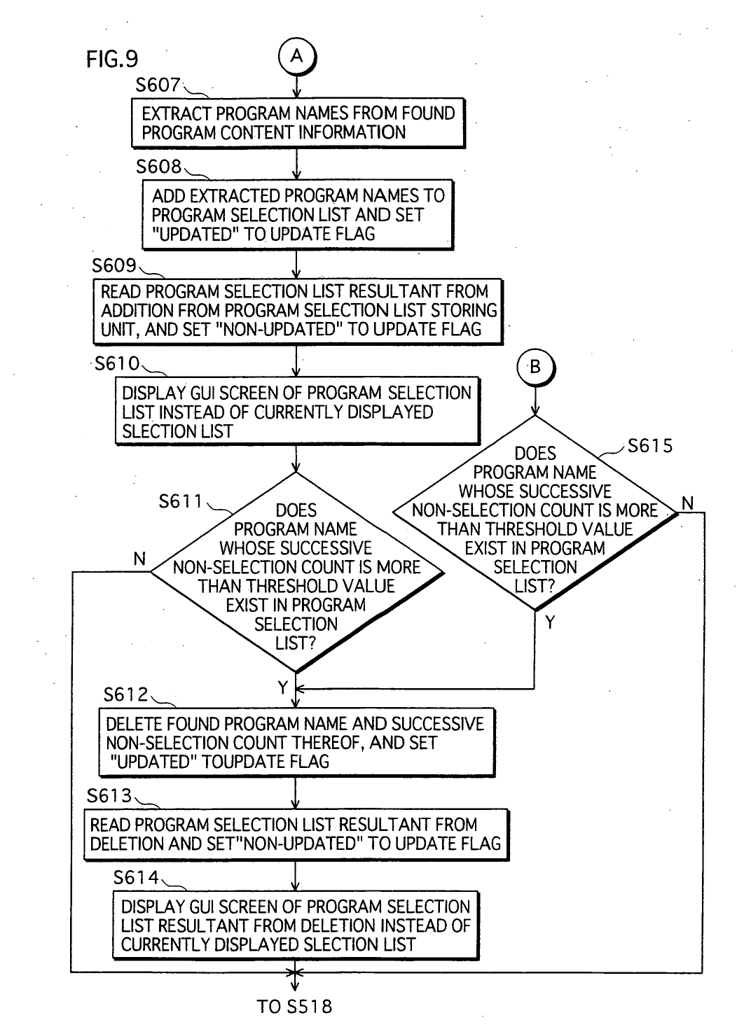

More specifically, as the flowcharts in FIG. 8 and FIG. 9 show, if the program name indicated by the piece of the program content information is included in the program selection list in step S601 of FIG. 6 (Step S601: Y), the program guide managing unit 107 deletes the program name and the successive non-selection count thereof from the program selection list, stores the deleted program selection list in the program selection list storing unit 108, and sets “updated” to the update flag (Step S701).

In FIG. 7, the same Step numbers as in FIG. 6 are given to the Steps of the same processing as in FIG. 6.

Next, after “updated” is set to the update flag, the program selection list managing unit 104 reads the selection list of the program names in the updated program selection list from the program selection list storing unit 108, and sets “non-updated” to the update flag, and outputs the selection list to the display control unit 106 (Step S702)

Next, the display control unit 106 generates a GUI screen of the selection list of the program names based on the program names input from the program selection list managing unit 104, deletes the old selection list currently displayed, and displays the GUI screen of the newly generated selection list on the display unit 105 (Step S703). Then, the display control unit 106 increments the successive non-selection count of the program name included in the updated program selection list (Step S704).

Also in the procedure for updating the program selection list in the second embodiment, the certain Steps in the flowcharts shown in FIG. 21 and FIG. 22 may be replaced with the corresponding Steps in the flowcharts shown in FIG. 8 and FIG. 9. In other words, if the program name indicated by the piece of the program content information is included in the complex program selection list in Step S2202 of FIG. 22 (Step S2202: Y), the program guide managing unit 207 may delete the program name and the successive non-selection count thereof from the complex program selection list, and the display control unit 206 may displays the program names included in the complex program selection list resultant from the deletion on the display unit 205.

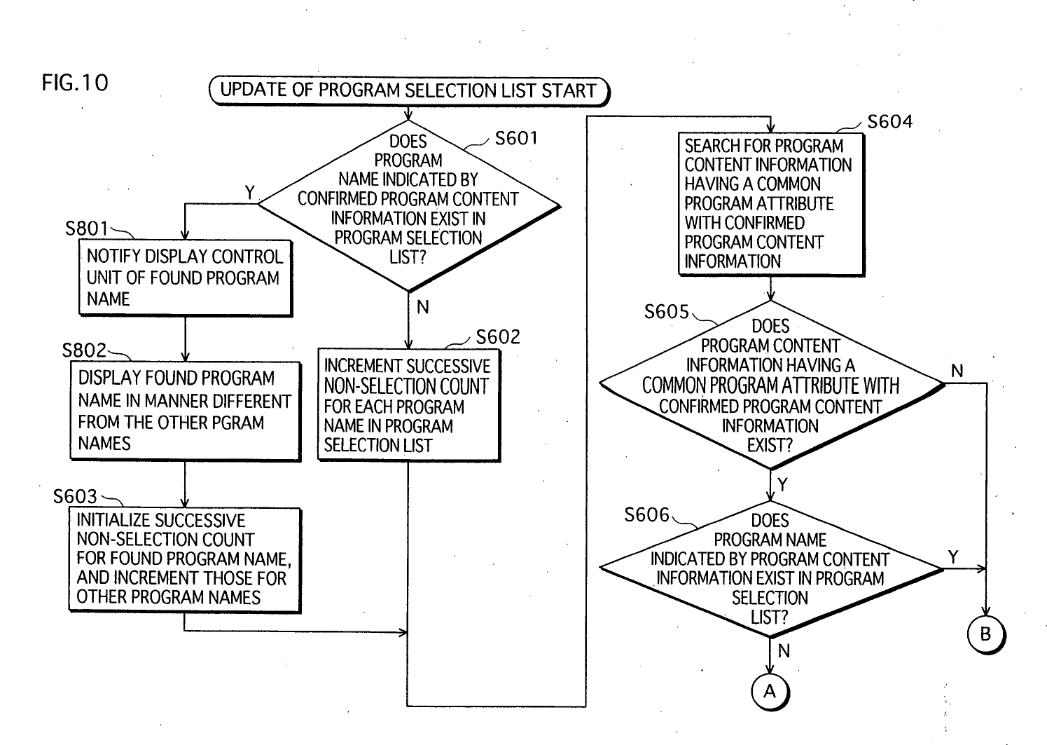

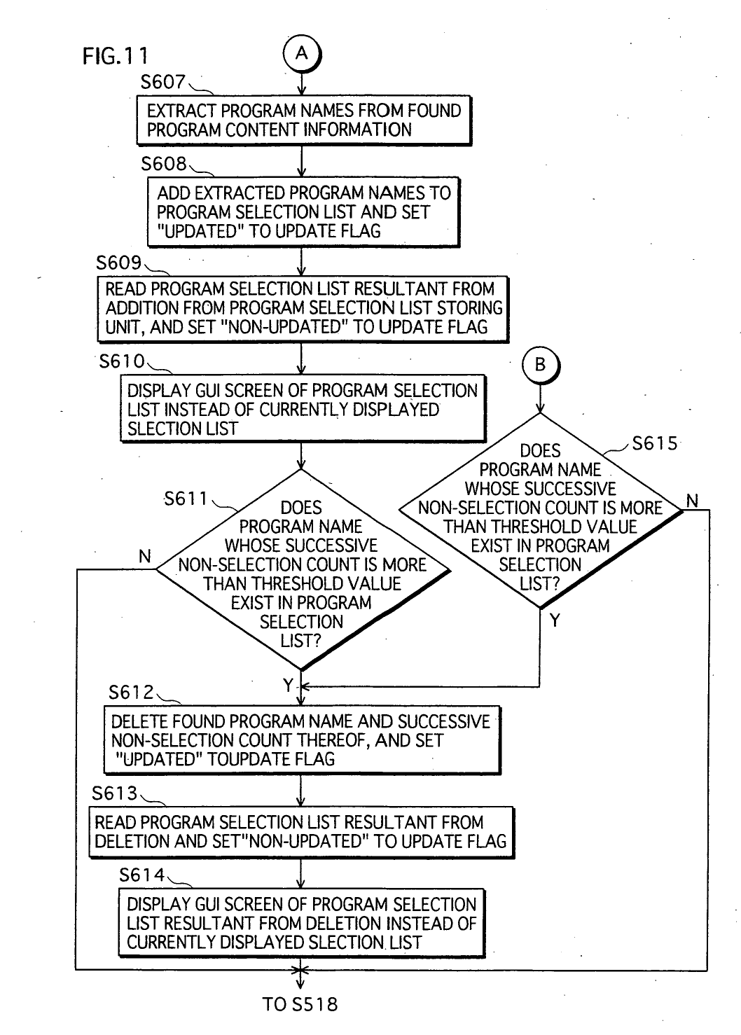

Also, as shown in the flowcharts of FIG. 10 and FIG. 11, if the program name indicated by the program content information is included in the program selection list in Step S601 of FIG. 6 (Step S601: Y), the program guide managing unit 107 may notify the display control unit 106 of the program name (Step S801), and the display control unit 106 may display the notified program name, included in the GUI screen of the selection list displayed on the display unit 105, in a manner different from the other program names in the list so as to show that the notified program name is “selected” (Step S802). For example, the notified program may be displayed in a different color, or an icon showing a character “selected” may be added to the program name.

In FIG. 8, the same Step numbers as in FIG. 6 are given to the Steps of the same processing as in FIG. 6.

Also, in the procedure for updating the program selection list in the second embodiment, the certain Steps in the flowcharts shown in FIG. 21 and FIG. 22 may be replaced with the corresponding Steps in the flowcharts shown in FIG. 8 and FIG. 9. In other words, the display control unit 206 may display the notified program name, included in the GUI screen of the complex program selection list displayed on the display unit 105, in a manner different from the other program names in the list so as to show that the broadcast program having the notified program name is “preprogrammed for viewing or recording”. For example, the notified program may be displayed in a different color, or an icon showing a character “selected” may be added to the program name.

(2) In the procedure for updating the program selection list of the first embodiment shown in FIG. 6, if a piece of program content information having the common program attribute exists (Step S605: Y), the program name is added to the program selection list (Step S608). However, instead of adding the program name to the program selection list, in the same manner as Step S510 of FIG. 5, the program guide managing unit 107 extracts, from the full program guide, a program guide constituted of time slots and broadcast channels in a predetermined range centered around the time slot and the broadcast channel with which the piece of the program content information is associated, to create the on-screen program guide, and displays the on-screen program guide on the display unit 105.

Also in the procedure for updating the program selection list of the second embodiment shown in the flowcharts of FIG. 20 and FIG. 21, instead of adding the program name to the program selection list, in the same manner as Step S2110 of FIG. 21, the program guide managing unit 207 may extract, from the correspondence program guide, a program guide constituted of time slots and broadcast channels in a predetermined range centered around the time slot and the broadcast channel with which the piece of the program content information is associated, to create the on-screen correspondence program guide, and displays the on-screen correspondence program guide on the display unit 105.

(3) In the first and second embodiments, each piece of the broadcast program information stored in the program information storing unit 110 includes the program content information showing the contents of the broadcast programs broadcast on the broadcast channels in a predetermined period. These programs broadcast on the channels in a predetermined period may be currently broadcast programs or programs to be broadcast in the future. Also, the programs may include programs broadcast in the past.
(4) In the first and second embodiments, the piece of the program content information that is selected and confirmed is highlighted on the GUI screen. However, the piece of the program content information may be displayed in a different manner as long as the piece can be distinguished from the other pieces. For example, different colors may be used for displaying the selected and confirmed piece of the program content information and the other pieces.

Also, the candidate name on the GUI screen of the selection list may not be highlighted, but may be displayed in a different manner as long as the candidate program name can be distinguished from the other program names in the selection list.

(5) The program selection support device 100 according to the first embodiment may be used for selecting a broadcast program for which recording is to be preprogrammed, or be used for selecting a broadcast program for which viewing is to be preprogrammed.

Specifically, a broadcast wave receiving device may includes the program selection support device 100, specify a piece of broadcast program information that is “selected and confirmed” based on the selection confirmation flag of each piece of the broadcast program information stored in the program information storing unit 110. Then, the broadcast wave receiving device may specify a broadcast program to be received, based on the time slot and the broadcast channel indicated by the piece of the broadcast program information, receive the specified program, and record the program.

Also in the second embodiment, the broadcast wave receiving device may include the program selection support device 200.

(6) Each of the on-screen program guide in the first embodiment and the on-screen correspondence program guide in the second embodiment is a program guide constituted of time slots and broadcast channels in a predetermined range centered around the time slot and the broadcast channel of a candidate program specified by the program selection instruction. However, it may not be centered around the candidate program, but may be a program guide constituted of time slots and broadcast channels in a predetermined range.
(7) In the first and second embodiments, the program selection list creating unit 109 or the program selection list creating unit 209 specifies, from the pieces of the program information stored in the program information storing unit 110, a program name satisfying a selection condition, based on the selection condition (e.g. attribute information such as a time slot, a broadcast channel, a genre name) input from the program selection condition input unit 111, creates a program selection list based on the specified program name, and stores the program selection list in the program selection list storing unit 108. However, the program selection list may be created based on a history of the program content information selected and confirmed by the user.

Specifically, the following operation is possible: Every time the program guide managing unit 107 sets “selected and confirmed” to the selection confirmation flag corresponding to the time slot, the broadcast channel and the piece of the program content information of the confirmed broadcast program, the program guide managing unit 107 extracts, from the piece of the program content information, pieces of information indicating attributes of the broadcast program (hereinafter called the “program attribute element information”) such as the program name of the broadcast program, the main performer name, the genre name, and stores each piece of the extracted program attribute element information in the program information storing unit 110 in association with an evaluation score which has been digitized based on the total counts of the extractions of the program attribute element information. Then, upon receiving a range of time slots and broadcast channel, which is a selection condition input from the remote control operated by the user, via the program selection condition input unit 111, the program selection list creating unit 109 specifies, from the pieces of the program attribute information stored in the program information storing unit 110, a piece of program attribute element information whose evaluation score is larger than a threshold value, and selects, from the pieces of the broadcast program information stored in the program information storing unit 110, a piece of a program content information including the specified piece of the program attribute element information within the input range of the time slots and the broadcast channels. Finally, the program selection list is created based on the program names included in the selected piece of the program content information.

Here, the “evaluation score” may be the number of extractions of the program attribute element information, or a value progressively weighted based on the number of extractions (e.g. the evaluation score is the number of extractions if the number of extractions is 1 to 3 time(s), and the evaluation score is twice the number of extractions if the number of extractions is 4 to 6, and the evaluation score is three times the number of extractions if the number of extractions is 7 to 9). Alternatively, the evaluation score may be a value obtained by weighing at every extraction. For example, a value equivalent to the broadcast duration (e.g. if the broadcast time is 1 hour, the value is 60) corresponding to the piece of the program content information including the piece of the program attribute element information may be added to the score at every extraction.

At every time of extraction of a piece of program attribute element information from the confirmed program content information, if the piece of the program attribute information is stored in the program information storing unit 110, the program guide managing unit 107 updates the evaluation score of the program attribute element information, and if not stored, the program guide managing unit 107 newly associates the piece of the program attribute information with an initial value of the evaluation score, and stores the piece of the program attribute information in the program information storing unit 110.

Here, “update” means, if the evaluation value is equal to the number of extractions, rewrite the evaluation score to increment the score by one, and if the evaluation value is weighted, “update” means to add a corresponding weighting value to the immediately previous evaluation value.

The “initial value” is “1” if the evaluation score is the number of extractions, and if the evaluation value is weighted, the initial value is a corresponding weight value.

The unit of extraction is not limited to the example above, and a minuter unit may be used. For example, the unit is not limited to the program name, but may be a keyword included in the program name (e.g. if the program name is “professional baseball YYG×TTG”, “professional baseball”, “YYG” and “TTG”).

The extraction of keywords can be performed by specifying the unit of extraction based on sings such as quotation marks, a character “x”, a space between characters, and so on.

(8) In the second embodiment, the complex program selection list is created by combining the base list and the non-base lists. However, it is possible to display the individual program selection list of each user as a provider belonging to the specified registration group on the display unit 105 in the procedure for creating the complex program selection list, instead of combining the base list and the non-base lists.

Specifically, the following is acceptable: In the procedure for creating the complex program selection list shown in FIG. 19, a pair of an external device ID belonging to the selected and specified registration group and the user ID, and a pair of an external device ID belonging to the registration source access-permitted group specified for the above pair and a user ID are displayed as user specifying information using GUI on the display unit 105. In accordance with user's selection from the pieces of the user specifying information input via the remote control 101, a piece of the program selection list associated with the selected user specifying information is individually displayed on the display unit 105. If this is the case, information (e.g. a user ID and a device ID associated with each list) for specifying the user to which the list belongs may be displayed with the list.

(9) In the second embodiment, in the procedure for creating the complex program selection list, all the program names included in the non-base lists are added to the base list regardless of whether the viewing or recording of the program is preprogrammed or not as long as the program names are not included in the base list. However, the program names may be added to the base list only in the case where viewing or recording of the programs are preprogrammed.
(10) In the second embodiment, in the on-screen correspondence program guide, the program content information of the program of which viewing or recording is preprogrammed is displayed with characters by adding preprogrammer specifying information. However, instead of displaying the preprogrammer specifying information by characters, it is possible to previously associate a color, a pattern, a symbol, a figure and so on with a user, and distinguish the program content information by the color, the pattern, the symbol, the figure and so on, or displaying characters in combination with the color, the pattern, the symbol, the figure and so on.

The preprogrammer specifying information may be structured by the user ID and the ID of the program selection support device that the user belongs to. If this is the case, the display control unit 206 may judge whether the user indicated by the preprogrammer specifying information is an internal user or an external user based on the program selection support device ID indicated by the preprogram information (i.e. if the program selection support device ID relating to the user is the same as the program selection support device ID input by the instruction for starting up the complex program selection list, the display control unit judges that the user is an internal user, and if it is not the same, the display control unit 206 judges that the user is an external user). Then, the preprogrammer specifying information of the internal user and the preprogrammer specifying information of the external user may be displayed in a manner they can be distinguished from each other. For example, the preprogrammer specifying information of the internal user may be displayed in red and the preprogrammer specifying information of the external user may be displayed in blue. Also, the preprogrammer specifying information of the internal user may be displayed in a square frame, and the preprogrammer specifying information of the external user may be displayed in an ellipsoidal frame.

This is not limited to the case where viewing or recording has preprogrammed. Provider specifying information specifying a provider of the provider of a program may be added to each program name included in the complex program selection list, and the provider information may be displayed as characters in the on-screen correspondence program guide, for each piece of the program content information of the programs included in the complex program selection list. Alternatively, a color, a pattern, a symbol, a figure and so on may be associated with each provider, and a color, a pattern, a symbol, a figure and so on corresponding to the program content information may be displayed instead of characters, or in combination with characters.

Specifically, in the flowcharts in FIG. 19 and FIG. 20 showing the operations for creating the complex program selection list, if the judgment result in Step S1911 is negative, the provider specifying information of the non-base lists as the comparison targets (i.e. the external device ID and the user ID associated in the individual program selection list with the non-base list) is recorded in the base list, and then, the Step S1913 is performed. As a result, it is possible to add the provider specifying information of the non-base list to the program names of non-preprogrammed programs included in the created complex program selection list, and instructs the program guide managing unit 207 to create a correspondence program guide including the user specifying information of the non-base list, based on the complex program selection list, instruct the display control unit 206 to display the program guide as the on-screen correspondence program guide.

Also in this case, in the same manner as the case of the preprogrammer specifying information, the provider specifying information of the internal user and the provider specifying information of the external user may be displayed in different manners. Furthermore, the preprogrammer specifying information and the provider specifying information may be displayed in different manners.

The display control unit 206 may prestore a threshold value indicating the maximum number of broadcast programs that can be recorded at the same time (The threshold value is determined based on the number of tuners included in a program recording device to which the program selection support device 200 is connected.). The display control unit 206 counts the number of the preprogrammed broadcast programs to be broadcast in the same time slot by counting the number of pieces of the program content information that include the preprogrammer specifying information of the internal user and are associated with the same time slot. If the counted number is larger than the threshold value, the pieces of the program content information associated with the same time slot may be displayed in a manner different from a manner in which the other pieces of program content information are displayed.

Here, the “the same time slot” means that part or all of the time slot of one broadcast program overlaps the time slot of the other program.

For example, a background of a piece of program content information associated with the same time slot may be displayed in “gray color”, and the other pieces of program content information may be displayed in “white color”.

(11) In the second embodiment of the present invention, in the on-screen correspondence program guide, the program content information of a program of which viewing or recording is preprogrammed is displayed with characters by adding preprogrammer specifying information. However, in addition, the pieces of the program content information may be classified according to the registration group to which the user specified by the preprogrammer specifying information belongs, and displayed in a different manner for each group.

Also, regarding the provider specifying information, the registration group may be specified in the same manner as described above, and the pieces of the provider specifying information may be classified according to the registration group, and displayed in a different manner for each group.

Specifically, in the modification described in the item (10) above and the flowcharts shown in FIG. 19 and FIG. 20 representing the procedure for the complex program selection, the non-base lists and the complex program selection list are created by adding the information of the group to which the preprogrammer or the provider designated by the startup instruction belongs, to the preprogrammer specifying information or the provider specifying information, and the correspondence program guide is created based on the complex program guide selection list and each piece of the broadcast program information stored in the program information storing unit 110, and the on-screen correspondence program guide is created from the correspondence program guide.

For example, a piece of the preprogrammer specifying information or provider specifying information belonging to the registration group 1 may be displayed in “red color”, and a piece of the preprogrammer specifying information or provider specifying information belonging to the registration group 2 may be displayed in “blue color”.

(12) In the modification shown in the second embodiment and the item (10) described above, in the on-screen correspondence program guide, the preprogram information and the preprogrammer specifying information is displayed for a piece of program content information of a broadcast of which recording has been preprogrammed by a user of an external device. However, transfer availability information indicating whether a recorded program is allowed to be transferred to other user may be additionally displayed.

Specifically, the transfer availability information is added to the individual program selection list and associated with the recording preprogramming status. After recording of a program as to which the user has input the transfer availability at the time of preprogramming the recording, the transfer availability information indicating whether transfer of the recorded program is allowed to be transfer is added, and associated with the recording preprogramming status. In Step S1911 of the procedure for creating the complex program selection list shown in FIG. 19 and FIG. 20, the transfer availability corresponding to both the preprogramming information and the preprogrammer specifying information is recorded to included the transfer availability information in the correspondence program guide, and as a result, the transfer availability information can be displayed in the on-screen correspondence program guide.

(13) In the second embodiment, the number of times the individual program selection list is read from the program selection list storing unit 208 is not limited. However, the number may be limited.

Specifically, a limit value indicating the upper limit of the number of reading of the individual program selection list may be added to the individual program selection list, and the user previously may set the limit value. Every time the program selection list creating unit 209 reads the individual program selection list, the program selection list creating unit 209 acquires the limit value. If the limit value is not “0”, the program selection list creating unit 209 may decrement the value by 1, and if the limit value is “0”, the program selection list creating unit 209 may stop reading.

The limit value describe above may be set only if the individual program selection list is read from an external device.

As a result, it is possible to limit the range of the distribution of the individual program selection list.

(14) In the second embodiment, the complex program guide is created by combining the base list and the non-base lists. However, it is possible to create the complex program guide by combining only the non-base lists without combining the base list.

Specifically, in the procedure for creating the complex program list shown in FIG. 19 and FIG. 20, the complex program selection list may be created based only on the non-base lists by omitting the Step S1902, and repeating comparison with one of the acquired non-base lists and another one of the non-base lists in Step S1908 to Step S1913.

Also, the complex program selection list may be created by combining non-base lists constituted of only program names of programs of which viewing or recording is preprogrammed.

(15) In the second embodiment, the program selection list displayed on the display unit 105 includes only program names. However, whether viewing of each program is preprogrammed or not may be displayed as well. In the same manner, also regarding the modification of the item (9), whether viewing or recording of each program is preprogrammed or not may be displayed.
(16) In the first embodiment and the second embodiment, the program information storing unit 110 may store the pieces of the broadcast program information of the programs to be broadcast within a predetermined period, with classifying them according to the types of the broadcast wave (e.g. terrestrial wave, BS, CS, and analogue), and in the program selection list, each program name may be associated with the type of the broadcast wave. In the procedure for program selection shown in FIG. 5 or the procedure for the complex program selection shown in FIG. 21, when an instruction for selecting a program name in the program selection list is input, whether the type of the broadcast wave associated with the selected program name is the same as the program name selected at the immediately preceding time may be judged. If they are not the same, information indicating the change of the type of the broadcast wave may be displayed before the on-screen program guide or the on-screen correspondence program guide is displayed.

For example a message “program guide of BS is now displayed” or an illustration representing the same may be displayed.

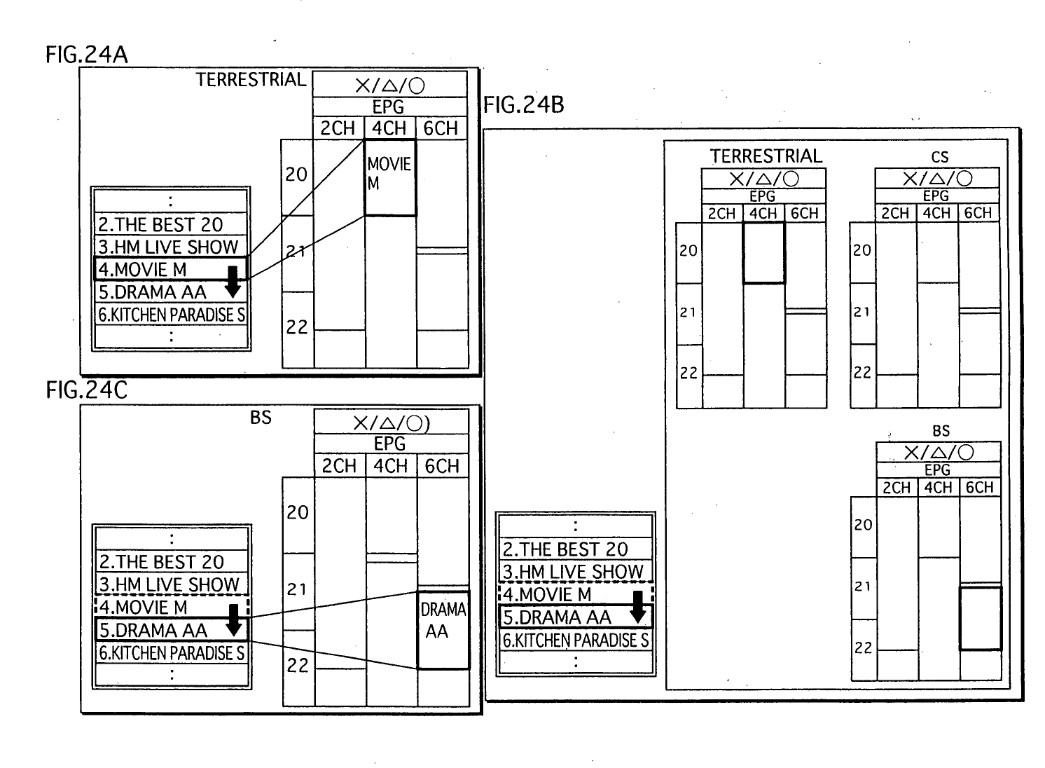

Instead of displaying the message, the program content information corresponding to the broadcast channels and the time slots within a predetermined range may be extracted from the full broadcast program guide. And as FIG. 24A to FIG. 24C show, it is possible to notify the user of that the broadcast wave type is switched after displaying the program guide of all the broadcast wave types.

FIG. 24A shows the status before the switch, FIG. 24B shows the status in the middle of the switch, and FIG. 24C shows the status after the switch.

Also, instead of displaying the broadcast program guide by extraction from the full program guide, it is possible that the program guide storing unit 110 stores an image of the program guide for each broadcast wave type, and the image of the program guide is displayed when the type of the broadcast wave is switched.

Also, the above-described switching may be displayed as animation of zooming-out and zooming-in.

For example, FIG. 24B may be displayed with zooming-out animation, and FIG. 24C may be displayed with zooming-in animation.

(17) In the procedure for user registration in the second embodiment, a designation of password may be received from an external user at the time of the registration request, and the password may be associated with the ID of the external user and the external device ID to be the registration information and stored in the registration information storing unit 213. In the procedure for acquiring the external user program list, the external device may provide the requested individual program selection list only when receiving the designated password from the program selection support device as the source of the request for the individual program selection list.

This prevents unauthorized access from device other than the registered devices.

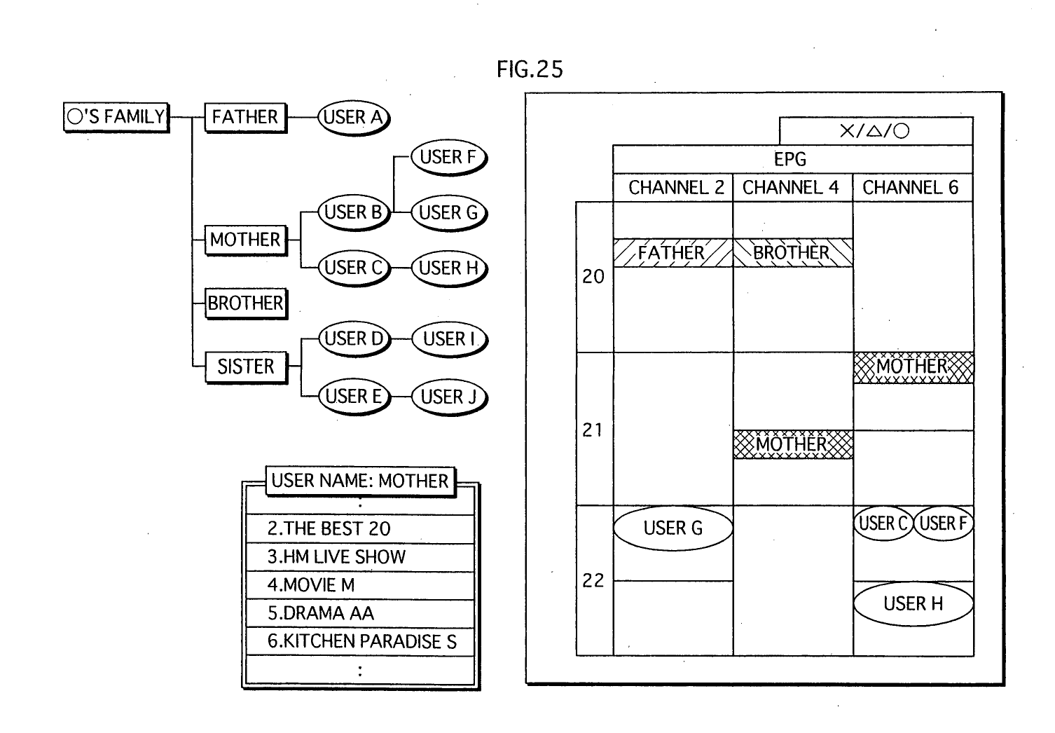

(18) Also, in the second embodiment, the procedure for the user registration and the procedure for acquiring the external user program list are performed via the network connection with the external device. However, the external user may previously record the information required for the above-described procedures on a recording medium via the program selection support device of the external device, and the recording medium may be provided to a user at the registration destination, and the above-described procedures may be performed by the user at the registration destination causing his program selection support device to read the information recorded on the recording medium.
(19) At the starting up of the procedure for the complex program selection, the program selection list creating unit 209 may read per-user registration group information having the same ID as the ID of the program selection support device that is started up, from the registration information storing unit 213, and output the read-out per-user registration group information to the display control unit 206, and cause the display control unit 206 to create a GUI having a tree structure shown in FIG. 25, which indicates the relation among the users belonging to the registration group registered with the per-user registration group information.

As a result, each user can easily recognize the registration relation in the per-user registration group information via the GUI. Also, the user can easily designate a registration group in the procedure for the complex program-selection via GUI objects (the rectangular or ellipsoidal images representing “Father”, “User A” and so on in the tree structure of FIG. 25).

(20) Each of the program selection support devices 100 and 200 in the first and the second embodiments specifically is a computer system constructed from a microprocessor, a RAM, a ROM, a hard disk unit, a display unit, a keyboard, a mouse, and so on. A computer program is stored in the RAM or the hard disk unit. The program selection support device carries out functions as a result of the microprocessor operating in accordance with the computer program. Here, the computer program is structured by combining a plurality of instructions codes representing instructions for the computer for achieving the predetermined functions.

A part or all of the components included in each of the program selection support device may be realized as one system LSI (Large Scale Integration). System LSI is a super-multifunctional LSI manufactured by integrating a plurality of components on one chip. The system LSI is specifically a computer system structured from a microprocessor, a ROM, a RAM and the like. A computer program is stored on the RAM. The system LSI carries out functions as a result of the microprocessor operating in accordance with the computer program.

A part or all of the components included in each of the above-described devices may be structured by an IC card or a single module which is attachable to the device. The IC card or the module is a computer system structured from a microprocessor, a ROM, a RAM and the like. The IC card and the module may include the above-described super-multifunctional LSI. The IC card or the module carries out functions as a result of the microprocessor operating in accordance with a computer program. The IC card or the module may be tamper-resistant.

### INDUSTRIAL APPLICABILITY

The present invention can be used in a program selection support device that supports selection of a broadcast program, as a technique to easily and quickly select a program.

1. A program selection support device that displays a program selection list that is a list of identifiers of broadcast programs selected as selection candidates from among all the broadcast programs to be broadcast in a predetermined period, the program selection support device comprising:
a group registration unit operable to classify pieces of provider specifying information, each specifying a list provider that permits the program selection support device to display a program selection list of the list provider, into groups according to an attribute of each list provider, and register the pieces of provider specifying information on a recording medium in one-to-one association with the groups;
a program selection list registration unit operable to register a program selection list of each list provider on the recording medium in one-to-one association with the pieces of provider specifying information;
a group designation unit operable to designate one of the groups registered on the recording medium; and
a display control unit operable to acquire the program selection list of the list provider specified by one of the pieces of provider specifying information belonging to the designated group, and display a program selection list including identifiers of selection candidates included in the acquired program selection list.

2. The program selection support device of claim 1, wherein
the display control unit includes
a program information storing subunit operable to store a plurality of pieces of broadcast program information each indicating a correspondence between a piece of program content information including an identifier of a broadcast program to be broadcast in the predetermined period and a broadcast channel and a time slot of the broadcast program, and
a program guide displaying subunit operable to specify, on every reception of a designation of the identifier input by a user from the program selection list displayed by the display control unit, a predetermined range of broadcast channels and time slots including the broadcast channel and the time slot corresponding to the piece of program content information including the identifier input by the user, based on the pieces of broadcast program information, and display a program guide in which pieces of program content information respectively corresponding to the specified broadcast channels and time slots are arranged, one of coordinate axes of the program guide indicating the broadcast channels and the other one of the coordinate axes indicating the time slots.

3. The program selection support device of claim 2, wherein
the program selection list of the list provider includes selection status information for each identifier included in the program selection list, the selection status information indicating whether the identifier has already been selected, and
if the selection status information indicates that the identifier has already been selected, the program guide displaying subunit displays the program guide to which are added the selection status information and a piece of the provider specifying information associated with the program selection list of the list provider to the piece of program content information including the identifier.

4. The program selection support device of claim 3, wherein
each piece of program content information includes a program attribute, and
the program selection support device further comprises:
a program selection unit operable to select a piece of the program content information from the program guide in accordance with a user's instruction;
a relevant program search unit operable to search for a piece of program content information including a common program attribute with the selected one of the pieces of the program content; and
a program list update unit operable, if the piece of program content information including the common program attributed has found by the search, to add an identifier included in the found piece of the program content information to the program selection list displayed by the display control unit.

5. The program selection support device of claim 4, wherein
the program list update unit deletes, from the program selection list displayed by the display control unit, an identifier included in a piece of the program content information that has not been selected within a predetermined number of selections performed by the program selection unit.

6. The program selection support device of claim 5 further comprising
a judging unit operable to judge whether the identifier included in the selected one of the pieces of the program content is contained in the program selection list displayed by the display control unit, wherein
if the judging unit judges affirmatively, the program list update unit deletes the identifier from the program selection list displayed by the display control unit.

7. The program selection support device of claim 5 further comprising
a judging unit operable to judge whether the identifier included in the selected one of the pieces of the program content is contained in the program selection list, wherein
if the judging unit judges affirmatively, the display unit displays the identifier in a display mode different from a display mode for the other identifiers in the program selection list.

8. The program selection support device of claim 7 further comprising:
a receiving unit operable to receive, from the user, a selection condition specifying the program attribute; and
a list creating unit operable to specify a piece of program content information including a common program attribute with the program attribute specified by the selection condition, and create the program selection list based on the identifier included in the specified piece of program content information.

9. The program selection support device of claim 8 further comprising:
an extraction unit operable, on every selection of a piece of program content information, to extract the identifier and the program attribute from the selected piece of program content information; and
a recording unit operable to record the extracted identifier and program attribute in the program information storing subunit in association with an evaluation score to be updated based on a number of extractions performed by the extraction unit, wherein
the receiving unit receives a selection condition specifying a range of time slots and broadcast channels from the user,
the list creating unit further includes
a specifying subunit operable to specify an identifier or a program attribute whose evaluation score is more than a threshold value, and
a selection subunit operable to select a piece of program content information including the specified identifier or program attribute within the specified range of time slots and broadcast channels, and
the list creating unit creates the program selection list based on the selected piece of program content information.

10. The program selection support device of claim 2, wherein
the program selection support device is connected with external program support devices via a network,
the group registration unit further includes
a receiving subunit operable to receive pieces of provider specifying information, each specifying a list provider who has requested registration, from the external program support devices,
a group specification receiving subunit operable to receive a group designation based on an attribute of the list provider, and
a list provider registration subunit operable to classify the pieces of provider specifying information into a group designated by the group designation, and record the pieces of provider specifying information on the recording medium, and
the program selection list registration unit includes
an acquiring subunit operable to acquire, from the external program support device, a program selection list associated with a piece of provider specifying information of a list provider who has requested registration, and
an acquired list registration subunit operable to register, on the recording medium, the acquired program selection list registration in one-to-one association with a piece of provider specifying information of the list provider who has requested registration.

11. The program selection support device of claim 10, wherein
each of the external program selection support devices comprises:
a group storing unit operable to classify the pieces of provider specifying information into groups according to an attribute of the list provider specified by each piece of provider specifying information, and store the classified pieces of provider specifying information; and
a program list storing unit operable to store a program list of each list provider in one-to-one association with the pieces of provider specifying information, and
the receiving subunit receives, from each external program selection support device, a designation of a group that is permitted to access the program selection list of the list provider that has requested registration,
the list provider registration subunit classifies the group into a group designated as to a piece of provider specifying information of the list provider and register the group on the recording medium,
the acquiring subunit notifies the external program selection support device of the group and acquires the program selection list associated with each piece of the provider specifying information belonging to the group,
the display control unit further acquires the program selection list associated with the provider specifying information belonging to the group that is permitted to access the program selection list by the list provider specified by the piece of provider specifying information belonging to the designated group, and displays the program selection list including identifiers of selection candidates included in the acquired program selection list.

12. The program selection support device of claim 2, wherein
the display control unit includes
a list acquiring subunit operable to acquire a program selection list of each list provider specified by the provider specifying information belonging to the designated group,
a list creating subunit operable to create the program selection list including the identifiers of all the selection candidates included in each of the acquired program selection lists, and
a list displaying subunit operable to display the created program selection list.

13. The program selection support device of claim 2, wherein
the display control unit includes
a provider designation receiving unit operable to receive a designation of a piece of provider specifying information whose program selection list is to be displayed among the pieces of provider specifying information belonging to the designated group,
a designated list acquiring unit operable to acquire a program selection list associated with the designated piece of provider specifying information, and
a displaying subunit operable to display the acquired program selection list.

14. The program selection support device of claim 2, wherein
the program selection list of the list provider includes selection status information for each identifier included in the program selection list, the selection status information indicating whether the identifier has already been selected, and
the display control unit includes
a list acquiring subunit operable to acquire a program selection list of each list provider specified by the provider specifying information belonging to the designated group,
a list creating subunit operable to create the program selection list including only the identifiers whose selection status information indicates that the identifier has already been selected, and
a list displaying unit operable to display the created program selection list.

15. The program selection support device of claim 14, wherein
the recording medium registers thereon a user program selection list that is a program selection list of a user of the program selection support device, and
the list displaying unit displays a complex program selection list including the created program selection list and the user program selection list.

16. A program selection support method for displaying a program selection list that is a list of identifiers of broadcast programs selected as selection candidates from among all the broadcast programs to be broadcast in a predetermined period, the program selection support method comprising:
a group registration step of classifying pieces of provider specifying information, each specifying a list provider that permits the program selection support device to display a program selection list of the list provider, into groups according to an attribute of each list provider, and registering the pieces of provider specifying information on a recording medium in one-to-one association with the groups;
a program selection list registration step of registering a program selection list of each list provider on the recording medium in one-to-one association with the pieces of provider specifying information;
a group designation step of designating one of the groups registered on the recording medium; and
a display control step of acquiring the program selection list of the list provider specified by one of the pieces of provider specifying information belonging to the designated group, and displaying a program selection list including identifiers of selection candidates included in the acquired program selection list.

17. A computer program for having a program selection support device execute a program selection support processing procedure, the program selection support device displaying a program selection list that is a list of identifiers of broadcast programs selected as selection candidates from among all the broadcast programs to be broadcast in a predetermined period, the program selection support processing procedure comprising:
a group registration step of classifying pieces of provider specifying information, each specifying a list provider that permits the program selection support device to display a program selection list of the list provider, into groups according to an attribute of each list provider, and registering the pieces of provider specifying information on a recording medium in one-to-one association with the groups;
a program selection list registration step of registering a program selection list of each list provider on the recording medium in one-to-one association with the pieces of provider specifying information;
a group designation step of designating one of the groups registered on the recording medium; and
a display control step of acquiring the program selection list of the list provider specified by one of the pieces of provider specifying information belonging to the designated group, and displaying a program selection list including identifiers of selection candidates included in the acquired program selection list.

18. An integrated circuit that is used for a program selection support device that displays a program selection list that is a list of identifiers of broadcast programs selected as selection candidates from among all the broadcast programs to be broadcast in a predetermined period, the integrated circuit comprising:
a group registration unit operable to classify pieces of provider specifying information, each specifying a list provider that permits the program selection support device to display a program selection list of the list provider, into groups according to an attribute of each list provider, and register the pieces of provider specifying information on a recording medium in one-to-one association with the groups;
a program selection list registration unit operable to register a program selection list of each list provider on the recording medium in one-to-one association with the pieces of provider specifying information;
a group designation unit operable to designate one of the groups registered on the recording medium; and
a display control unit operable to acquire the program selection list of the list provider specified by one of the pieces of provider specifying information belonging to the designated group, and display a program selection list including identifiers of selection candidates included in the acquired program selection list.

19. The program selection support device of claim 2, wherein
the list providers includes a user of an external program selection support device other than the program selection support device,
each piece of provider specifying information includes device specifying information specifying a program selection support device to be used by the list provider,
the display control unit includes
a list acquiring unit operable to acquire a program selection list of the list provider specified by the provider specifying information belonging to the designated group,
a list creating unit operable to create a specifying-information-added program selection list by adding the piece of provider specifying information of the list provider to the identifier of the selection candidate included in the acquired program selection list, and
a program information creating unit operable to create, based on the pieces of broadcast program information and the specifying-information-added program selection list, specifying-information-added broadcast program information by adding the piece of the provider specifying information to a piece of program content information including a common identifier with identifiers included in the specifying-information-added program selection list, and
the program guide displaying unit displays, based on the specifying-information-added broadcast program information, among pieces of program content information corresponding to the specified broadcast channels and time slots, pieces of the specifying-information-added broadcast program information whose device identifying information indicates the external program selection support device and pieces of the specifying-information-added broadcast program information whose device identifying information indicates the program selection support device in different manners.

20. The program selection support device of claim 19, wherein
the program selection list of the list provider includes a pair of preprogramming status information and transferability information for each identifier included in the program selection list of the list provider, the preprogramming status information indicating whether the selection candidate associated with the identifier has already been preprogrammed for recording and the transferability information indicating whether the preprogrammed selection candidate is transferable,
if the preprogramming status information associated with the identifier of the selection candidate included in the program selection list indicates that the selection candidate has already been preprogrammed, the list creating unit creates the specifying-information-added program selection list by adding the preprogramming status information and the transferability information to the identifier,
the program information creating unit creates, based on the pieces of broadcast program information and the created specifying-information-added program selection list, the specifying-information-added broadcast program information by further adding the preprogramming status information and the transferability information to the piece of program content information including a common identifier with identifiers each including the preprogramming status information and the transferability information and included in the specifying-information-added program selection list, and
the program guide displaying unit displays, based on the specifying-information-added broadcast program information to which the preprogramming status information and the transferability information are added, among pieces of program content information corresponding to the specified broadcast channels and time slots, pieces of the specifying-information-added broadcast program information whose device identifying information indicates the external program selection support device and pieces of the specifying-information-added broadcast program information whose device identifying information indicates the program selection support device in different manners.

21. The program selection support device of claim 2, wherein
the group designation unit designates a plurality of groups from among the groups registered on the recording medium,
the display control unit includes
a list acquiring subunit operable to acquire a program selection list of each list provider specified by pieces of provider specifying information belonging to the designated groups,
a list creating subunit operable to create the specifying-information-added program selection list by adding the pieces of the provider specifying information and pieces of group specifying information specifying the list providers, and
a program information creating unit operable to create, based on the pieces of broadcast program information and the specifying-information-added program selection list, specifying-information-added broadcast program information by adding the pieces of the provider specifying information to a piece of program content information including a common identifier with identifiers included in the specifying-information-added program selection list, and
the program guide displaying unit displays, based on the specifying-information-added program guide information, among pieces of program content information corresponding to the specified broadcast channels and time slots, pieces of the specifying-information-added broadcast program information in different display modes depending on the group indicated by the group specifying information.

22. The program selection support device of claim 2, wherein
the list providers includes a user of an external program selection support device other than the program selection support device,
each piece of provider specifying information includes device specifying information specifying a program selection support device to be used by the list provider,
the program selection list of the list provider includes selection status information for each identifier included in the program selection list, the selection status information indicating whether the identifier has already been selected, and
the display control unit includes
a list acquiring subunit operable to acquire a program selection list of each list provider specified by the provider specifying information belonging to the designated group,
a list creating unit operable to create a specifying-information-added program selection list by adding the piece of provider specifying information of the list provider to the identifier of the selection candidate included in the acquired program selection list, and
a program information creating unit operable to create, based on the pieces of broadcast program information and the specifying-information-added program selection list, specifying-information-added broadcast program information by adding the selection status information and the piece of the provider specifying information to a piece of program content information including a common identifier with identifiers included in the specifying-information-added program selection list, and
the program guide displaying unit includes
a program guide creating subunit operable to specify broadcast channels and time slots including the broadcast channel and the time slot corresponding to the piece of program content information including the identifier input by the user, based on the specifying-information-added broadcast program information, to create the program guide,
a judging subunit operable to judge whether the number of pieces of the program content information, associated with the same time slot and including the selection status information and provider specifying information whose device specifying information indicates the program selection support device, is more than a threshold value, and
a displaying subunit operable, if the judging subunit judges affirmatively, to display the program content information associated with the same time slot in a display mode different from a display mode for the other pieces of program content information are displayed.
